(19) United States
(12) Patent Application Publication
(10) Pub. No.: US 2025/0183644 A1
(43) Pub. Date: Jun. 5, 2025

(54) SEAL MEMBER, SYSTEM AND METHOD OF SEALING A MICRO TRENCH

(71) Applicant: GIBRALTAR INDUSTRIES, North Baltimore, OH (US)

(72) Inventors: Eric I. DEVINE, Bowling Green, OH (US); Bryan E. MCKINNEY, Woodville, OH (US); Shubham B. THAKARE, Bowling Green, OH (US); Gregory J. SPILLANE, Cary, IL (US)

(21) Appl. No.: 18/833,660

(22) PCT Filed: Jan. 27, 2023
(86) PCT No.: PCT/US2023/011725

§ 371 Date: Jul. 26, 2024

Related U.S. Application Data
(63) Continuation-in-part of application No. PCT/US2024/026419, filed on Apr. 26, 2024.
(60) Provisional application No. 63/304,013, filed on Jan. 28, 2022.
(60) Provisional application No. 63/492,071, filed on Mar. 24, 2023.

(51) Int. Cl. H02G 15/00; H02G 1/06; H02G 9/02

(52) U.S. Cl. CPC H02G 15/003; H02G 1/06; H02G 9/02

(57) ABSTRACT

A variety of spoolable gaskets are configured to seat within a micro trench to form a water tight, damage-resistant seal. In some aspects, the seal may be removed to allow for subsequent access to utilities installed therein. The seal has a suitable compressive strength to support the trench walls without damaging the pavement and accommodates expansion and contraction of the micro trench and pavement caused by changes in temperature. Systems and methods involving the seal member are also disclosed.

### CROSS REFERENCE TO RELATED APPLICATIONS

This application claims priority as a national stage application pursuant to 35 U.S.C. § 371 of PCT Application serial number PCT/US2023/011725 filed on Jan. 27, 2023 which claims priority to U.S. provisional patent application Ser. No. 63/304,013 filed on Jan. 28, 2022, each of which is are incorporated by reference in their entireties. This application also claims priority as a continuation-in-part application pursuant to 35 U.S.C. § 120 to PCT Application serial number PCT/US2024/026419 filed Apr. 26, 2024 which claims priority to U.S. provisional patent application Ser. No. 63/462,071 filed on Apr. 26, 2023, each of which are also incorporated by reference in their entireties.

### TECHNICAL FIELD

The present teachings relate to a system and method for sealing a micro trench in pavement and methods of installation thereof, that is able to protect and provide access to utilities therein.

### BACKGROUND

Micro trenching, or slot-cut trenching, is the process of cutting a small groove or small channel in pavement. Micro trenching is a growing practice used to install utilities such as fiber optic cable networks or other broadband network lines in a variety of residential, commercial, and industrial settings. The grooves for small and micro-trenches are usually one quarter to several one or two inches wide with depths of up to 12, 18, or even 24 inches. The minimum depth and width for micro-trenches is most typically dictated by the size of the cutting implement, the dimensions of the utility being installed, and/or other conditions at the site, although the minimum depth could be 1.00 inches, 1.50 inches, or 2-3 inches. Most commonly, and as used herein, “micro trench” is a trench formed in concrete, pavement, or other similar solid surfaces at a width between 0.10 to 2.00 inches wide and 0.50 to 18.00 inches deep, with more preferred dimensions of 0.25 to 1.50 inches wide and 1.00 to 12.00 inches deep. All of the aforementioned dimensions have a tolerance of plus.

Micro trenching is preferred as a low-impact deployment methodology. It can be utilized without damaging or disrupting existing infrastructure, especially in comparison to existing trenching machinery requiring a width of at least 5-6 inches (with an even larger footprint during the trenching operation itself). Alternative excavation techniques also rely on a larger trench profile and/or substantial removal of pavement, which takes more time and involves greater expense. Specifically, equipment and labor for excavation and reinstatement are greater, and the larger footprint requires significant amounts of time and extensive roadway/lane closures. In comparison, micro trenching is faster, lower cost, and generally more efficient because it requires fewer resources. Further, since micro trenching requires less space and is generally less intrusive, installation by micro trenching usually results in less closures/changes to traffic patterns. And when properly installed, micro trenches are not visually obtrusive, so as to often go unnoticed by casual observers.

Conventional devices and methods that may be useful for forming a micro-trench can be found in numerous patents, including United States Patent Publications 20160376767A1; 20180106015A1; 20180292027A1; and 20200149659A1, while United States patent publication 20200227904A1 provides an example of a spooling system for installing cables and similar materials. Generally speaking, these are representative of the state of the art in which. These publications all contemplate a continuous installation system relying on a truck or trailer that initially creates the micro trench and then fills it with a concrete-based material that can be selected to color-match the roadway. The fill material requires a set time of about 2 hours, with 30 to 40 minutes being preferred. Various cements and accelerators are recommended as the means to adjust the set time. Notably, even when relying on the most preferred conditions, the set times for these methods exceed the speed at which a micro-trench is dug, meaning that the reinstatement process is rate-limiting and dictates the pace at which operations can proceed.

Other conventional reinstatement methods involve the use of a flowable fill, such as that disclosed in EP1569021A1 and US20160201291A1. As an example, flowable fill may include hot applied rubberized sealants, cold asphalt material, or cementitious grouts (e.g., cement-based grout, bituminous sealer, etc.) placed directly on top of the buried utility (e.g., fiber optic cables, etc.). Especially after these fill materials set/cure, they do not allow convenient access to the underlying utility, thereby making subsequent service (e.g., for modifications, repair, or replacement) more difficult and expensive. A common means of overcoming these challenges is to simply create a new trench, usually in or adjacent to the existing trench and install separate/new utilities (and possibly remove the older line), all of which requires additional materials and labor costs. Because of the precision required to avoid damaging adjacent pavement and/or utilities, servicing flowable filled trenches and micro trenches tends to be time-consuming and increases the risk for other complications.

Conventional methods of reinstatement tend to have a relatively short life span in comparison to the original pavement material in which they are used. For example, pavement comprising hot mix asphalt (HMA) has minimal strength in the horizontal plane, especially at surface temperatures above 35° C. As a result of the differences in strength of adjacent materials at elevated (or reduced) temperatures, expansion and contraction is further exacerbated, with the resulting weakness and variability leading to gaps, cracks, potholes, and other defects in the riding or walking surface. Current flowable fill materials themselves can also be too flexible or have poor bond strength, allowing the trench walls to break apart or the fill material to debond and become dislodged. Bond failure, cracks, and potholes all lead to water ingress in or around the trench during freeze and thaw cycles, causing more damage and accelerating the degradation of the roadway/surface. In order to accommodate traffic, it is believed that the use of a reinstatement/fill material is preferred so as to retain the physical integrity of the sealing system.

Since the need to connect an end user site and a given utility line often recurs over a period of time, secondary, perpendicular trenches intersect and overlap with the primary/longitudinal (following the direction of the road or walkway) trench. These crossover points lead create junctions along multiple and intersecting planes (i.e., at least twice as many in comparison to a single trench) that are all susceptible to the temperature cycling issues noted above. Thus, branching trenches have even greater chances for damage, pavement failure, and an overall reduction in lifecycle for the seal, the trench, and the roadway itself. The use of flowable fill or other non-matching or comparatively incompatible materials, both at the intersection points and/or between the secondary trench and the original surface/roadway itself, further compounds the problems.

FIG. 1A depicts a conventional sealing gasket A used in non-micro trench installations according to the prior art, it will be understood that the two-dimensional view of FIG. 1 (like many others in this disclosure) is transverse to the direction of the trench T, which is cut into material M (meaning the sides and bottom of the trench T are formed by material M). Gasket A seals and covers fiber optics or other cables C with the interstices V therebetween left void or provided with fill materials. It must be noted that the gasket A is ineffective for micro trenches and largely ineffective for other reinstatement applications where the trench is formed in non-concrete materials, including asphalt. Another problem with gasket A is that it may cause distress and distortion in selected materials, such as asphalt (which has a significantly lower horizontal shear strength in comparison to concrete), possibly because the compressive strength of the preformed sealant/gasket A and the flexible nature of the surrounding material M. Thus, not only will sealant A fail to form a proper seal, it may exhibit “shoving” when used in asphalt, (see FIG. 1B) resulting in ripples across asphalt, causing distortion and disruption of the surface. Rutting, depressions, cracking, upheaval, disintegration, and other failures or disruptions may also occur. Also, extruded members with interior voids, like gasket A with its multiple adjacent cells, can sometimes present manufacturing and other challenges.

FIG. 1C shows a compression deflection curve for the preformed sealant A having a 13/16″ width. In concrete, the preformed sealant A of this size would be used in expansion joints with an opening range of about 0.375″ to 0.688,″ which may generally correspond to the operating range of a micro trench cut at about ½″ which is about 0.375″ to 0.625.″ While the preformed sealant A of this size may have expected to provide an adequate seal such micro trench opening, quantitative results confirm that the preformed sealant A is not effective for use in a material having different compressive qualities and horizontal strength of concrete, such as asphalt. As shown in FIG. 1C, at the minimum joint opening the compressive force (stored energy) of the preformed sealant A is at a maximum. For example, a joint opening of about 0.375″ corresponds to about 0.437″ compressive extension, or about 20 psi compressive stress. Further, at hotter temperatures, asphalt may be softer and more flexible.

U.S. Pat. No. 10,146,024 describes a trenching system in which a foldable base with articulating members can be insert into a standard sized trench. A plug member with a micro trench formed in its top facing is received by the articulating members on opposing sidewalls of the trench, with the micro trench then itself receiving a portion of cap material that can be placed over its top. As such, this trenching system can only accommodate large trenches, and it requires multiple different elements (the foldable base followed by the plug followed by the cap) to effectuate its final seal, thereby increasing the number of components required, costs, and overall complexity.

Given the foregoing, new and improved sealing systems (possibly but not necessarily including reinstantement materials), removable and/or resealable members, and methods for creating and reinstating micro trenches are needed. In particular, improved systems would provide a fast and reliable seal, allow for subsequent access to the utilities contained in the micro trench, enable minimal disruptions to the surrounding roadway/surface, and possess superior ability to withstand environmental and traffic conditions for that roadway/surface, irrespective of whether a reinstatement material is used. Materials and methods that can be installed at a rate that matches or exceeds the speed of the existing pavement cutting operations would also be welcomed, as would a system that is capable of coupling together extended spools of seal members without interrupting the trenching operation. Finally, seals that minimize or eliminate the need for additional materials (adhesives, fillers, lubricants, etc.) and/or that can be easily oriented and positioned within the trench are ideal.

### DESCRIPTION OF THE DRAWINGS

The present teachings may be better understood by reference to the following detailed description taken in connection with the following illustrations, wherein:

FIGS. 1A and 1B are side and top views of a preformed sealant A of the prior art typically used in sealing expansion joints in concrete FIG. 1C shows a compression deflection curve for the preformed sealant A;

FIG. 2 is a side view of an embodiment of a sealant system or apparatus in accordance with various disclosed aspects;

FIG. 3 is a side view of the embodiment of of FIG. 2 positioned in a micro trench in accordance with various disclosed aspects;

FIG. 4 is a top view of an embodiment of a sealant system or apparatus positioned in a micro trench in accordance with various disclosed aspects;

FIG. 5 illustrates method of installing an embodiment of a sealant system or apparatus positioned in a micro trench in accordance with various disclosed aspects;

FIG. 6 is a side view of another embodiment of a sealant system or apparatus in accordance with various disclosed aspects;

FIG. 7 is a side view of another embodiment of a sealant system or apparatus positioned in a micro trench in accordance with various disclosed aspects;

FIG. 8 is a compression deflection curve of a sealant system or apparatus in accordance with various disclosed aspects;

FIG. 9 schematic view illustrating a testing core and the test fixture configured to determine compatibility of a sealant system or apparatus in a material in accordance with various disclosed aspects;

FIG. 10 is a photograph of a trial installation of a sealant system or apparatus in a trench at a testing site in accordance with various disclosed aspects;

FIG. 11 are force/deflection curves for core tests and core testing samples at 3.22 psi in accordance with various disclosed aspects;

FIG. 12 are force/deflection curves for core tests and core testing samples at 9.4 psi in accordance with various disclosed aspects;

FIG. 13 are force/deflection curves for core tests and core testing samples at 20 psi in accordance with various disclosed aspects;

FIGS. 14A and 14B are photographs of a trial installation of a sealant system or apparatus in a trench at a testing site over time in accordance with various disclosed aspects;

FIG. 15 is a side view of an alternative embodiment of a sealant system or apparatus in accordance with various disclosed aspects;

FIG. 16 is a side view of the embodiment of FIG. 15 positioned in a micro trench in accordance with various disclosed aspects;

FIGS. 17A and 17B show, respectively speaking, a three dimensional, perspective view and a bottom view of an installation machine in accordance with various disclosed aspects; and

FIG. 18 is a schematic side view of a platform useful for simultaneously laying fiber, cable, or other spooled media within a trench, while also providing foam backfill and a sealant system in accordance with various disclosed aspects.

FIG. 19 is a side view illustration of a splice between seal members made according to certain aspects of the invention.

FIGS. 20A and 20B are schematic illustrations of cutting tools appropriate for use with the splicing operations according to certain aspects of the invention.

FIG. 21 is a transverse schematic and sectional view of a trench sealed with a gasket according to the prior art. The trench shape and cable positioning in FIG. 21 are applicable to any of the gaskets shown in FIGS. 2A to 4, as well as any other embodiments contemplated herein.

FIGS. 22A to 22F are transverse schematic and sectional views of exemplary gaskets according to various taxonomies described herein. Any of these gaskets may be substituted as element A in FIG. 1, while cable C may be positioned below, within, or co-extruded into selected aspects of these gaskets. These gaskets are particularly amenable to use in a system employing a foam reinstating material.

FIGS. 23A to 23F are three-dimensional cross-sectional views of portions of selected gaskets according to various disclosed aspects, with the letter designation in each of these Figures corresponding to the grouping and taxonomy disclosed in Table A and illustrated in the corresponding FIGS. 22A to 22F.

FIG. 24 is a transverse schematic and sectional view of an exemplary gasket according to another aspect described herein in which reinstatement materials, such as foam, are not required. This aspect can also be used as stand-alone seal or in combination with an adhesive applied to the sidewalls of the trench.

### DETAILED DESCRIPTION

Reference will now be made in detail to embodiments of the present teachings, examples of which are illustrated in the accompanying drawings. It is to be understood that other embodiments may be utilized and structural and functional changes may be made without departing from the scope of the present teachings. Moreover, features of the embodiments may be combined, switched, or altered without departing from the scope of the present teachings, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

A spoolable, branched, and T-shaped seal member and a specially formulated open or closed cell, curable foam can be implemented as part of a micro trenching system. These components can be provided on a single, unitary trailer or vehicle, or they can be retrofitted with/into existing trenching equipment and operations. The seal member itself may be removable and serviceable, while the installation of foam and/or the seal member results in a sealed micro trench that is water tight, comparatively resilient, and resistant to damage caused by heavy usage and/or environmental factors.

The seal member has suitable compressive strength to support the trench walls without damaging adjacent pavement (or other roadway/surface materials). The construction of the seal member will accommodate expansion and contraction caused by changes in temperature (i.e., the freeze/thaw cycle) and/or traffic load while remaining firmly locked into any reinstating material (when used), and it can be provided as a spooled material, which is ideally suited for existing installation machines and further enables the seal member to be dragged, dabbed, or otherwise exposed to an adhesive as it is laid down into the trench and/or in contact with the utility line(s).

The foam is provided as a two part liquid, making it ideal for storage in and in situ dispensing from tanks. After the parts are mixed, the resultant material can flow and expand around any objects positioned within the trench (e.g., the utility line(s), the seal member, etc.) and then cure into a closed or open cell solid material.

The sealing system and method may accommodate multiple parallel and/or intersecting/perpendicular micro trenches within a given road, street or other pathway/surface, irrespective of whether provided through intersections of cross streets or at various junctions from a mainline in a street to an end user/property adjacent to that street. The system is capable of withstanding vehicle and/or pedestrian travel, varying environmental conditions, and other wear and tear. Additionally, the disclosed micro trench seal may allow for removal, targeted replacement of the utility, and reuse, all while maintaining integrity of the original micro trench. The system is also configured to operate continuously by relying upon specialized tooling that enables the splicing of seal members from separate spools without pausing operations (i.e., without stopping cutting, reinstating, or sealing of the micro trench). As one non-limiting example, the system includes a cutting tool with a blade that partially removes the top flange and/or central body from the trailing edge of a seal member wound onto a first spool and/or the leading edge of a seal member wound onto a second spool. The cutting tool integrates or the system includes a separate holder that positions these leading and trailing edges, both for purposes of cutting and to allow a fastening implement to couple the leading and trailing edges together. In one aspect, that fastening implement may deliver one or more metal (copper, steel, etc.) or sufficiently hardened plastic staple, joint, or clip so as to hold the two edges together, preferably through overlapping portions of the main body and/or the top flange.

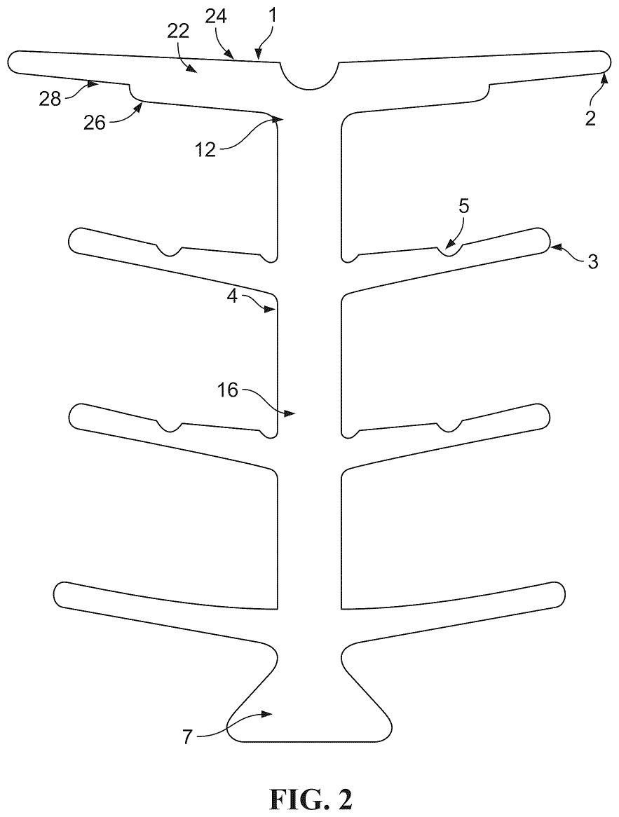

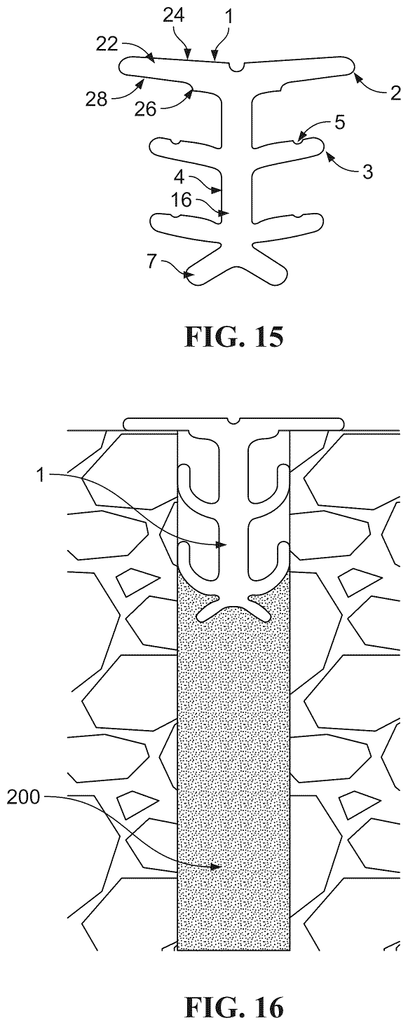

Turning to FIGS. 2-3 and 15-16, seal member 1 has a core T-shape, with the stem or main body 4 defining a central structural axis. A flat head or top flange 2 is positioned at the top end 12a of the body 4, while a plurality of appendages or protrusions 3 extend radially (perpendicular to or an angle) from central section 16a of the body 4. At the lower end 14a, an engagement feature 7 allows reinstating material, such as a foam, to flow and cure around the feature to keep the member 1 locked in place within the trench. The feature may take the form of a solid triangular shape (FIG. 2), an inverted V-shape (FIG. 15), or other similar structures, provided that the radial extension of the feature 7 is smaller than the corresponding radial extension of the set of shortest protrusion 3 (usually, the bottom-most set of protrusions 6).

As used herein, “axial” refers to the vertical direction of the member 1 as shown in the figures, while “radial” extensions will trace a generally horizontal direction although, unless otherwise stated herein, radial protrusions, extensions, and the like may be provided at a perpendicular or angled orientation relative to the central axis coinciding with the axial length of the main body 4. Also, references to “trench” and “micro trench” may be used synonymously, depending upon the specific context of their use.

It will also be understood that the member 1 is illustrated in cross section, but it will be manufactured (e.g., by way of extrusion) continuous web so that it can be reeled around a spool or otherwise gathered for subsequent dispensing and use. Thus, the cross sections shown in FIGS. 2, 15, and elsewhere are part of a body that otherwise can run on for extended lengths (as would be expected and needed for the seal member to be unspooled and positioned into a micro trench).

The seal 1 may be inserted into a micro trench 200 in any suitable manner, including by inserting the second end 14a first with the protrusion(s) 3 extending into contact with walls of the micro trench as described in more detail below. More specifically, the micro trench may include sidewalls 204 and an opening 206. The seal 1 may engage a surface of the pavement 202 generally adjacent to the micro trench. The seal 1 is ideally formed from an appropriate polymeric resin selected for the particular temperature and pressure conditions encountered in trenching operations. In one embodiment, the material can be a thermoset elastomer material. In another embodiment, the resin material can be a thermoplastic material. In other embodiments, the material may be a combination of the foregoing. The material can be resistant to environmental conditions such as water, ozone, oxidation, and UV.

The shape of the seal 1 may be formed using an extrusion process and may be cured to achieve its final desired properties. The seal 1 may be machine molded in a single continuous step so as to facilitate spooling. The entire seal 1 may be formed from the same material or different portions of the seal 1 may be formed from different materials that are subsequently adhered, welded, or otherwise bonded together. For example, the protrusions 3 or the ends of the protrusions may be formed from a more flexible rubber material or the top flange 2 may be formed from harder materials able to withstand wear from environmental conditions and use.

Examples of suitable materials include, but are not limited to, rubber-like polymers including, polyisoprene, butadiene rubbers, styrene-butadiene copolymers, such as Buna S and SBR, cis-polybutadiene, cis-polyisoprene, nitrile elastomers or NBR rubbers (also known as acrylonitrile and butadiene copolymers) such as Buna N, butyl rubbers including copolymers of isobutylene and isoprene, ethylene-propylene monomer (EDM), ethylene-propylene-diene monomer (EPDM), neoprene (polychloroprene), polysulfide rubbers (thiokols), ethylene-propylene rubbers (RPDM), urethane elastomers, and silicone rubbers such as dimethysilanediol polymers and polydimethyl siloxane, fluoroelastomer, polyacrylate elastomer, polyethylene (chlorinated, chlorosulfonated), styrene-isoprene-styrene (SIS), styrene-butadiene-styrene (SBS), EPDM-polypropylene blend, and combinations of two or more thereof.

Other suitable materials may include, but are not limited to, plastics such as polycarbonate; acrylonitrile butadiene styrene (ABS); polycarbonate/acrylonitrile butadiene styrene alloys (PC-ABS); polybutylene terephthalate (PBT); polyethylene therephthalate (PET); polyphenylene oxide (PPO); polyphenylene sulfide (PPS); polyphenylene ether; modified polyphenylene ether containing polystyrene; liquid crystal polymers; polystyrene; styrene-acrylonitrile copolymer; rubber-reinforced polystyrene; poly ether ketone (PEEK); acrylic resins such as polymers and copolymers of alkyl esters of acrylic and methacrylic acid styrene-methyl methacrylate copolymer; styrene-methyl methacrylate-butadiene copolymer; polymethyl methacrylate; methyl methacrylate-styrene copolymer; polyvinyl acetate; polysulfone; polyether sulfone; polyether imide; polyarylate; polyamideimide; polyvinyl chloride; vinyl chloride-ethylene copolymer; vinyl chloride-vinyl acetate copolymer; polyimides, polyamides; polyolefins such as polyethylene; ultra high molecular weight polyethylene; high density polyethylene; linear low density polyethylene; polyethylene napthalate; polyethylene terephthalate; polypropylene; chlorinated polyethylene; ethylene acrylic acid copolymers; polyamides, for example, nylon 6, nylon 6,6, and the like; phenylene oxide resins; phenylene sulfide resins; polyoxymethylenes; polyesters; polyvinyl chloride; vinylidene chloride/vinyl chloride resins; and vinyl aromatic resins such as polystyrene; poly(vinylnaphthalene); poly(vinyltoluene); polyimides; polyaryletheretherketone; polyphthalamide; polyetheretherketones; polyaryletherketone, and combinations of two or more thereof.

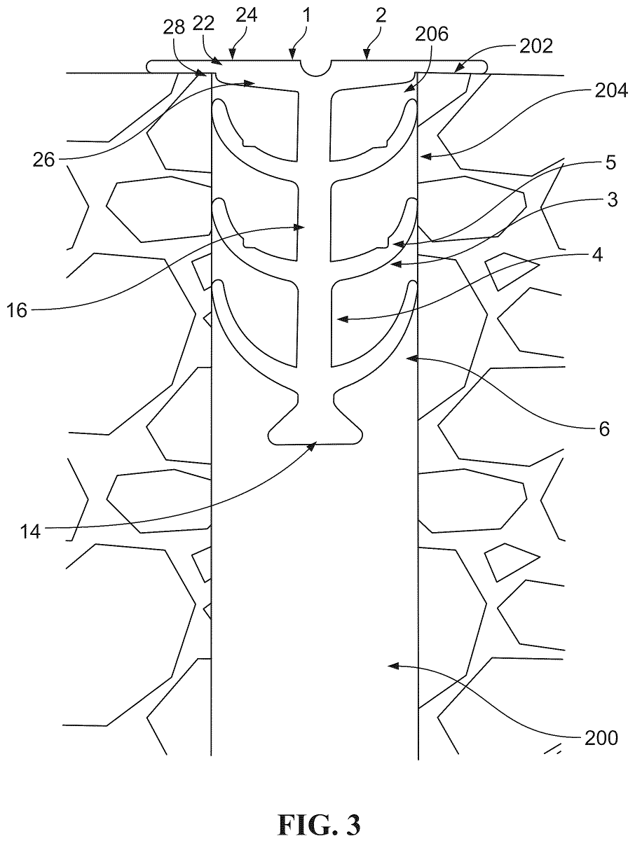

The stem 4 may include a first end 12a, a second end 14a, and a middle section 16a disposed between the first and second ends 12a, 14a. In an embodiment, the stem 4 may be inserted into the micro trench 200 such that most or all of the body 16a is generally below the surface of the pavement 210, see FIGS. 3 and 16. The length of the stem 4 may be customized at the installation site once the dimensions of the micro trench 200 are confirmed, for example, by cutting off any access material or length. In such cases, the sets of protrustions provided closest to the bottom end 14a will have a shorter radial extension in comparison to the sets above it. In this manner, the cut can be made immediately adjacent to the bottom edge of a protrusion, thereby converting the lowermost protrusion into the engagement feature 7.

The stem 4 may be thick enough, such as one quarter to one eighth of the width of the top web, to maintain the center of the joint generally without twisting or buckling, creating a self-centering effect. The first end 12a of the stem 4 may include the top flange 2 or the top flange 2 may be positioned thereon.

The top flange 2 may be removable from the stem 4. In an embodiment, the top flange 2 may be removed, and a different sealing mechanism or material used in conjunction with the stem 4. The top flange 2 may also be removed from the stem 4 and replaced by another top flange 2, for example, if the top flange 2 becomes damaged during use. The top flange 2 may also be removed and a coating of bituminous crack filler can be added to extend the life of the seal. The top flange 2 may also be configured to become detached from the stem 4 upon certain threshold pressure or conditions so that the stem remains in the micro trench 200 in the event the top flange 2 is pulled, detached, dislocated, or otherwise removed unintentionally or intentionally. In a non-limiting embodiment, the top flange 2 may be caught by a snow plow, street cleaner, truck, car, or the like. It may be desirable to have the top flange 2 selectively detached or be stripped off from the stem 4 under these conditions so that any damage is concentrated on the top flange 2 that can be replaced, rather than the stem 4 or the structure of the micro trench 200 and to prevent the entire seal 1 from inadvertently being removed from the micro trench.

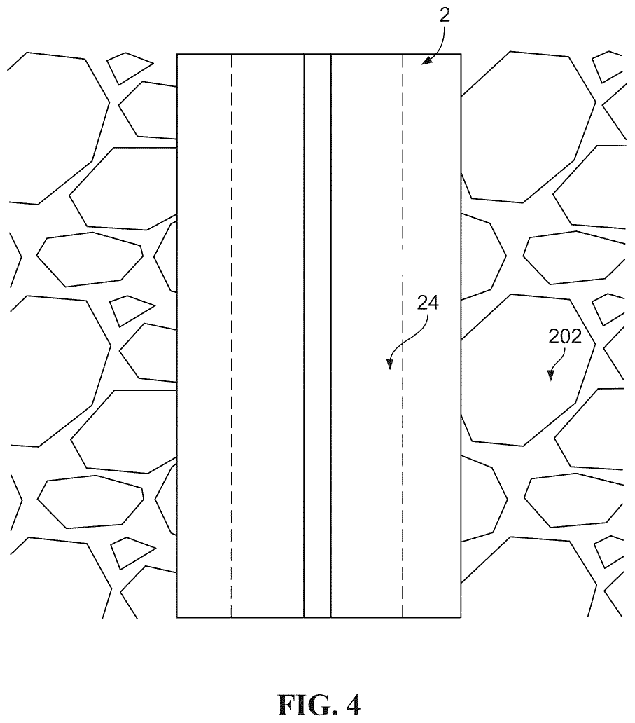

In an embodiment, the top flange 2 may include an elongated portion 22 that extends generally perpendicular (e.g., within 5 degrees of perpendicular) to the stem 4. The top flange 2 may be planar, flat, domed, rounded, squared, or be formed as any other shape as may be desirable. In an embodiment, the elongated portion 22 may include a sufficient length to accommodate a large portion or length of the micro trench 200, for example several feet, see FIG. 4 for example. In this embodiment, several stems 4 may attach to the top flange 2 across its length to secure the seal 1 into the micro trench 200. The elongated portion 22 of the top flange 2 may include a first face 24 and a second face 26, wherein the second face 26 may attach to or face the stem 4. As described above, in an embodiment, the top flange 2 may be removable from the stem 4. When installed in a micro trench 200 the first face 24 may face outwardly from the micro trench 200, see FIGS. 3-4, as well as FIG. 16. In an embodiment, the top flange 2 may be of sufficient width to span the entire trench and lay generally flat on the pavement surface, see FIGS. 3 and 16, e.g., it may lie such that only a centimeter or less is above or below the adjacent surface. The top flange 2 may be larger than the micro trench 200 such that the top flange is not fully inserted into the micro trench 200.

In an embodiment, the second face 26 of the top flange may include a notch 28 to fit on the edge of the micro trench 200 with the notch contacting a sidewall 204 of the micro trench 200 and the surface of the pavement 202. The notch 28 may help to form a seal and may provide additional securement of the seal 1 within the micro trench 200. The notch 28 may be sized for and be equal to the size of the micro trench opening. The notch 28 may be formed in the seal 1 at manufacture, or the notch 28 may be added at the installation site once the dimensions of the micro trench 200 are confirmed.

In another embodiment, the top flange 2 may generally be the same width as the micro trench 200, such that the top flange 2 may be inserted into the micro trench 200. The top flange 2 may create a seal against the side walls 204 of the micro trench 200 (similar to the protrusions described below) and another seal material or mechanism may be placed on top, such as a fill material. The top flange 2 may be any suitable shape including rectangular, circular, square, etc. The top flange 2 may be any suitable shape so as to keep debris or water out of the micro trench opening 206.

The seal 1 may include at least one protrusion 3 extending from the body 16a or second end 14a of the stem 4. The protrusion 3 may be formed as arms or wings that extend from opposite sides of the stem 4 in pairs to engage each of the corresponding side walls 204 of the micro trench 200. The protrusion 3 is a continuous flange that may extend perpendicularly or generally perpendicularly (i.e., radially away) from the stem 4, e.g., at angles within about 15 degrees of perpendicular. In an embodiment, the protrusions 3 extend from the stem 4 at an angle toward the top flange 2, see FIG. 2. Although FIG. 2 illustrates an embodiment having three sets of arms, or wings, it is noted that any number of protrusions may be used, such as 1, 2, 3, 4, 5, 6, 7, 8, 9, etc. In an embodiment, the protrusion is of a sufficient length to maintain may contact the sidewall of the sidewalls 204 of the micro trench 200 with normal variation in temperature and expansion or contraction of the pavement. The length of the protrusions 3 may be customized at the installation site once the dimensions of the micro trench 200 are confirmed, for example, by cutting off any access material or length. As described herein, asphalt or HMA may be particularly susceptible to variations in temperature and can result in changes in width of the micro trench 200.

The protrusions 3 may extend at approximately the same radial distance on either side of the stem, so as to allow easily centering the seal 1 within a microtrench 200. Additionally, as shown in FIG. 3, the protrusions 3 may have the same comparative radial distance, although it is preferably smaller than the distance spanned by the top flange 2. Alternatively, the protrusions 3 may be shorter in length in comparison to top flange 2 (as shown in FIG. 15) and/or in comparison to one another, so that the distal edges and radial distance of each flange gets progressively smaller as the protrusions progress from the first end 12a to the second end 14a, as this arrangement allows for the seal 1 to interlock with a foam backfill material, as described below. The protrusions 3 may be formed as pairs so that each pair is positioned at a different axial distance (relative to the top flange), or the protrusions may be axially offset from one another so that the protrusions extend away from the central body in an alternating fashion as they move down the central body.

Notably, the protrusions 3 and the top flange 2 are of sufficient strength so that when positioned as shown in FIGS. 3 and 16, any foam backfill material will be impeded from flowing around the distal edges of the protrusions 3. In this manner, the seal insures that foam cannot and will not expand upward out of the trench or to otherwise be visible when the installation is complete.

One or more sets of the protrusions 3 may include one or more hinge points 5 that allow the seal 1 to fold against the pavement or side walls 204 of the micro trench 200, increasing the sealing area, see FIGS. 3 and 16. Owing to the continuous web nature of the sealing member 1, hinge points 5 are formed as continuous grooves. The top flange 2 may also include a hinge point 5.

In an embodiment, bottom-most set of protrusions 6 inserted into the micro trench may not include a hinge point 5 while the remaining, higher sets of protrusions 3 may include a hinge point 5, see FIG. 3. The bottom-most set of protrusions 6 not including the hinge point 5 may permit the seal to engage the micro-trench with more force than the other protrusions 6 with the hinge point 5—this may prevent the seal 1 from being pulled out of the micro-trench. Each protrusion 3 may operate independent of the others, creating a seal at each protrusion location that is custom to the shape and contours of the micro trench 200. In an embodiment, providing the additional sealing protrusions and hinges not only may better secure the seal 1 within the micro trench and create a seal at multiple locations, but can also provide continuous service even if the top flange 2 or a protrusion 2 is damaged or the pavement is compromised at one location. In these embodiments, when a force is applied to the top flange 2, it may shear before the entire seal 1 is removed from the micro trench.

In an embodiment, the location of the hinge 5 may be designed specifically for the opening dimensions of the micro trench 200 to maximize sealing yet control the outward force that would disturb asphalt. The hinge 5 may also ensure that less pressure is applied onto the side walls 204 of the micro trench where the asphalt in the micro trench may be the weakest. For example, the asphalt may be weaker toward the top of the opening of the micro trench. As a result, the protrusions 3 inserted into this area of the micro trench may include a hinge 5 to reduce the force and prevent too much force to be applied from the protrusions 3 to the side walls 204. On the other hand, the side walls 204 of the micro trench may be stronger further down into the micro trench. As a result, the protrusions 6 inserted into this area of the micro trench may not include a hinge 5 because damage due to the force of the protrusions may not be as much of a concern and instead, it may be desirable to have a greater force and seal in this area of the micro trench to further secure the seal 1 into the micro trench. The hinge 5 may be formed in the seal 1 at manufacture, or the hinge 5 may be added at the installation site once the dimensions of the micro trench 200 are confirmed.

Notably, the second end 14a will have a radial distance that does not exceed the reach of the top flange 2 and, more preferably smaller than the reach of the protrusion 3 immediate above and adjacent to it. However, in contrast to the protrusions 3, second end 14a may slope at an angle (in comparison to the generally perpendicular protrusions 3). In this manner, the end 14a may have a cross-sectional shape that is triangular (as seen in FIG. 3) or, by way of two angled legs, V-shaped (as seen in FIG. 15).

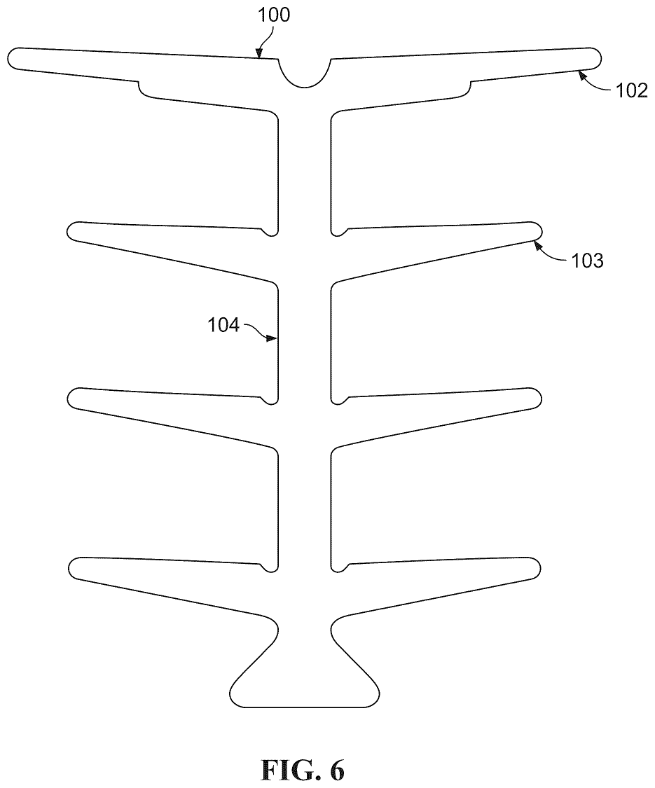

Although this embodiment describes protrusions 3 including a hinge point 5, it is noted that a micro trench seal 100 may also be provided without a hinge point, see FIGS. 6-7 (and this arrangement may be implemented on the seal 1 shown in FIG. 15). As disclosed herein, the seal 100 may include a top flange 102, at least one protrusion 103, and a stem 104. The incorporation of a hinge point may depend on the nature and integrity of the material forming and surrounding the micro trench, weather or environmental conditions, anticipated use of the road or pathway, material of the micro trench seal, and the like. In an example, the shape of the protrusions 103 may be altered to create variable force on the micro trench walls. The protrusions 103 may be made thinner or thicker, having a different circumference, of a material having a different flexibility, and the like.

The micro trench seal 100 and the seal 1 are exemplary embodiments. The present disclosure contemplates seals of different configurations. For example, the features disclosed above regarding seal 1 may be combined with micro trench seal 100 and the features disclosed above regarding micro trench seal 100 may be combined with seal 1. Moreover, the seal 1 and micro trench seal 100 may be of different configurations without departing from the present teachings. In one example, the seal 1 and/or micro trench seal 100 may be formed from the material described above, be serviceable and be of varying configurations that operatively fit within a micro trench as described above.

Thus, after the trench is cut and the utility is placed at the bottom of the trench a foaming material is sprayed or pumped into the trench. Before the foam fully reacts and cures, seal 1 is inserted in the top of the trench to confine the foam material within the trench. The foam material is an elastomeric material that can be urethane or silicone, with either a closed cell or open cell (preferred for waterproofing the trench) form upon curing. The foam material bonds to the trench walls and seal closing off the trench to water or incompressible materials to prevent spalling.

The interlocking arrangement of the seal 1 shown in FIGS. 15 and 16 improves the water tightness of the system and prevents the seal from being pulled from the trench.

Appropriate foam backfill materials are preferably elastomeric foams based on urethane and/or silicone polymer, provided as a single or plural component system. The foam should have a cream time in the range of 1-30 seconds, a gel time in the range of 2-60 seconds, and a tack free time in the range of 3-120 seconds. Once cured it has a core density of 0.5-60 pounds per cubic foot and a compressive strength of 2-200 psi. The foam could be hydrophobic to allow it to fully cure in hydrostatic conditions, allowing for installations in damp conditions. Typical geotechnical foam literature provided for Penefil 375. The foam should be capable of bonding to the pavement and the elastomeric sealing element. Also, the foam may be supplied in small hand mixed batches or bulk kits to allow pumping into the installation/trench.

Additionally or alternatively, as the seal member is disposed within the trench, it may be coated, dragged through, or otherwise come into contact with a curable adhesive. This adhesive would bond the seal member to the utility line(s) and/or the trench walls, so as to maintain the desired positioning of the seal member throughout the trenching and reinstating procedures. However, use of the adhesive—and of the foam itself—can be dictated by the conditions and needs of the installation. When used, the adhesive may be any common adhesively, preferably water based or a two-part system.

Pumping and injection systems should be electronically controlled to mix and place the appropriate volume of material in the trench based on the trench dimensions and the rate of travel to ensure a continuous process. The pump should include a spray head that applies the foam to the sidewalls of the trench to ensure full coverage of the trench walls. The head should be aligned with the trench such that the foam is applied so that the foam coats the trench walls and embeds itself in the seal. The pump should have the capability to heat the foam material to provide for a consistent cure rate and foam time. The pump should also include an air purge for when work stoppages occur.

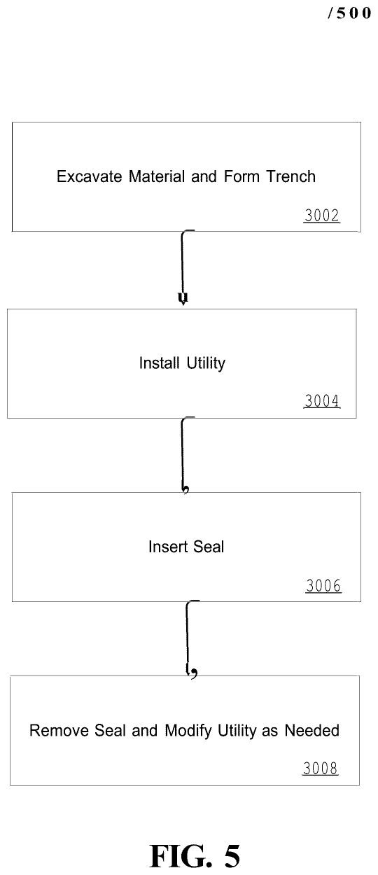

Turning to FIG. 5, shown is a method 300 of installing a seal 1. At step 3002, a micro trench is formed by excavating material such as pavement and dirt, to a desired width and depth as is necessary for the particular utility being installed. For example, the dimensions of a micro trench may range from 12 inches in depth, 0.5 inches in width, and 5,000 foot length—although these are merely exemplary any the micro trench may be of any appropriate dimension. At step 3004, a utility may be installed. The utility may include broadband network access such as fiber optic lines. At step 3006, the seal 1 may be inserted into the micro trench 200. The installation of the seal may occur concurrently with the installation of the utility. The installation of the seal 1 may be done by hand by pressing the seal 1 into the opening 206 of the micro trench 200 or by machine. In an embodiment, the structure of the seal 1 may enable installation of the seal 1 by hand where otherwise a machine would usually be needed. The seal 1 may provide improved on site installation capabilities and may minimize the need for additional machinery to facilitate installation of the seal 1. In this step 3006, coupling or splicing trailing and leading edges of separate sections of seal members is possible.

In an embodiment, an adhesive may be used to facilitate the installation of the seal 1 into the micro trench. The adhesive may be spray on, paint on, stick on, or the like. In an embodiment, a machine may be used to control the volume of an adhesive, such as a spray on adhesive, applied during installation. The seal 1 may be customized at the installation site by adjusting the length of the stem 4, the protrusions 3, the notch 28, and the hinges 5. For example, excess length of the stem 4 or protrusions 3 may be cut or material removed to form the notch 28 or hinges 5. In an embodiment, the seal 1 should be inserted to a depth that allows the top flange 2 to remain flush with the surface of the pavement 202. The seal 1 can be installed with or without adhesive. In an embodiment including adhesive, the adhesive should have a high enough viscosity to have a lubricating effect and a long enough open time to allow for adjustment of seal depth. If the micro trench 200 is cut excessively deep it may be desirable to partially fill the trench with dry fill material such as sand or spoils left over from when the trench was cut.

Because micro trenches are often deployed along hundreds or thousands of linear feet, another aspect of the invention relates to equipment that enables the continuous dispensing and positioning of the seal member. That is, the seal member is easily transported by winding it around a spool, but spools (and other similar storage means) can only hold a finite length of the seal member. When the micro trench length exceeds the length of seal member wound onto the spool, the system can be configured to include multiple spools and to splice the edges of seal members from separate spools, by way of a cutting tool and a fastener. In this manner, if 500 feet of seal member can be spooled onto a storage reel, a mobile platform outfitted with ten full reels positioned adjacent to one another will effectively enable installation of up to one mile of sealed micro trench. The ability to install greater length of trench without stopping is particularly beneficial to the extent that other aspects of the invention (e.g., the shape of the seal and/or the use of foam/adhesive) already increase the speed of micro trench operations.

In some aspects, the mobile platform might include one or more bars or a T-shaped hanging rods that allows spools to be loaded and removed from one or both ends of the bar/rod. Alternatively, the spools could each be associated with a movable stand or base. In either instance, a plurality of filled spools are readily accessible or in close proximity so as to minimize the amount of slack that must be created during the splicing operations described below.

The cutting tool can come in any number of arrangements. Critically, it will include a positioning member, such as a longitudinal channel and/or guide members, into which the leading and trailing edges of seal members from different spools are provided (with respect to the trailing edge, an operator will need to monitor progress and proactively couple these edges before they are placed into the trench, possibly with the further need to release the trailing edge from its spool). As implied by the name, the cutting tool also has a blade or implement to facilitate removing a portion of the seal member from one or both edges, ideally by way of cutting axially or radially into that seal member. This cut allows for positioning of the edges in order to fasten them with the fastening implement, while simultaneously retaining the apparent continuity of the top facing of the top flange (for cosmetic purposes). These positioning and cutting functions can be integrated within a single tool, or they can be provided as separate features of the system.

The fastening implement couples the trailing and leading edges together in a fast and cost efficient manner. It should be portable, easy to use, and avoid the need to cure or otherwise take time to effect a connection over a period time that might otherwise slow or disrupt installing of the sealing members. In these regards, the inventors have identified conventional industrial staples as an ideal solution.

Staples are attractive in part because of their ubiquitous nature. Further, they immediately couple members by having their opposing terminal edges of the staple penetrate the seal member, after which the staple edges are crimped inward so as to hole the staple securely in place. Simple U-shaped members made of copper, steel, other metals, sturdy plastics, or any other material that is sufficiently strong enough to pierce the material selected for the seal member and to withstand crimping. Other possibilities include clips, which rely on a biasing member to hold the edges together, and/or double-ended receiving joints where the edges can be slid into and/or secured to opposing sides of the joint member.

The fastening implement can be a stand alone feature, such as a hand held stapler so as to provide the operator with greater freedom to manipulate and position the necessary components. Alternatively, the stapling mechanism could be integrated within a portion of the cutting tool so as to guarantee consistent and proper positioning of the trailing and leading edges throughout the splicing operation (i.e., positioning the separate edges, cutting/removing a portion of one of the edges, and coupling the edges via the fastener/fastening implement).

The cutting tool can be any number of implements, from a hand held device up to an integrated workstation on a mobile platform. In operation, it includes a positioning and/or securing mechanism, such as a slot, spring-loaded grippers, or the like. A blade or cutting surface (die) can move across one edge of the securing mechanism so as to create a clean and angled or shaped cut through a portion of the seal member. The use of an angled cut (e.g., as seen along the leading edge 31b in FIG. 19) insures that the edges do not have to be perfectly aligned prior to fastening. A second positioning and/or securing mechanism can be provided and spaced apart from the first so as to allow both the lead and trailing edges to be held independently.

The tool can also include flanges (e.g., horizontal members on one or both transverse edges of the securing mechanism). These flanges may allow for holding and positioning the tool, and/or they may serve as means to attach or fasten the tool in place on a mobile platform, preferably adjacent to the spools carrying the seal members. Alternatively, the tool could be two or four blocks spaced apart to define a channel, with a guillotine-style cutting implement also provided.

At step 3008, the seal 1 or the top flange 2 may be removed as necessary. The components may be removed to allow access to the utility in order to fix or replace the utility, or the components may be removed and replaced if due to damage or wear and tear, as for example, by a snow plow. The seal 1 is able to allow continued access to the utility through its duration of use while both maintaining its integrity within the micro trench and adapting to the changing conditions of the micro trench due to various environmental conditions such as varying temperature. Notably, step 3008 is optional; however, when it is employed, the seal that was removed may be reused or repurposed to reseal the micro trench according to at least some subset of the previously mentioned steps 3002, 3004, 3006.

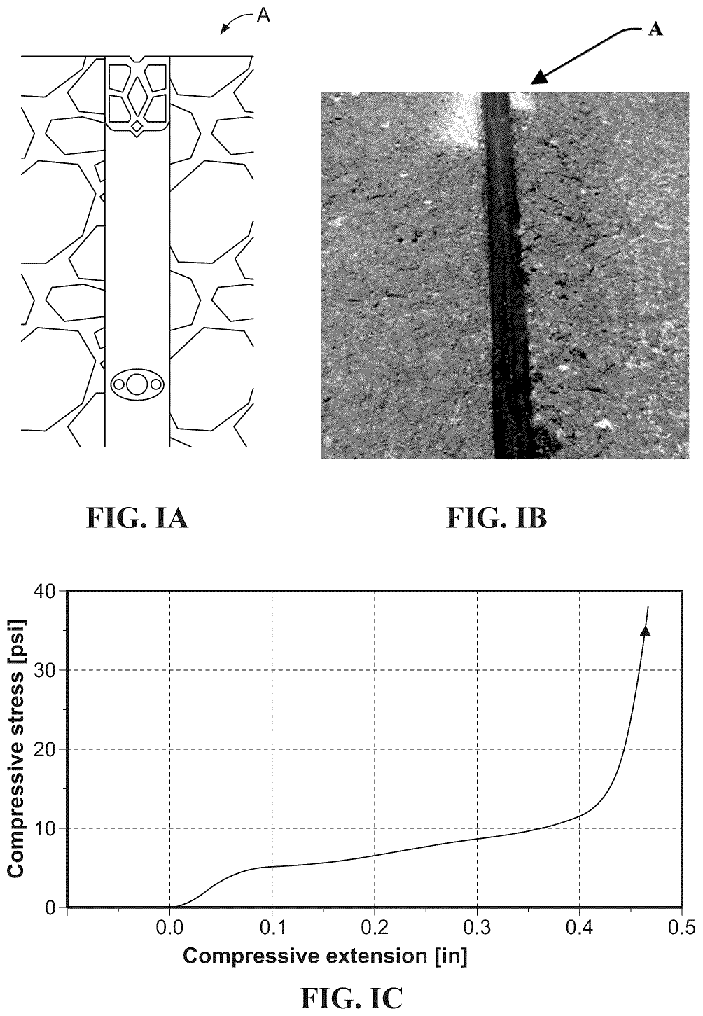

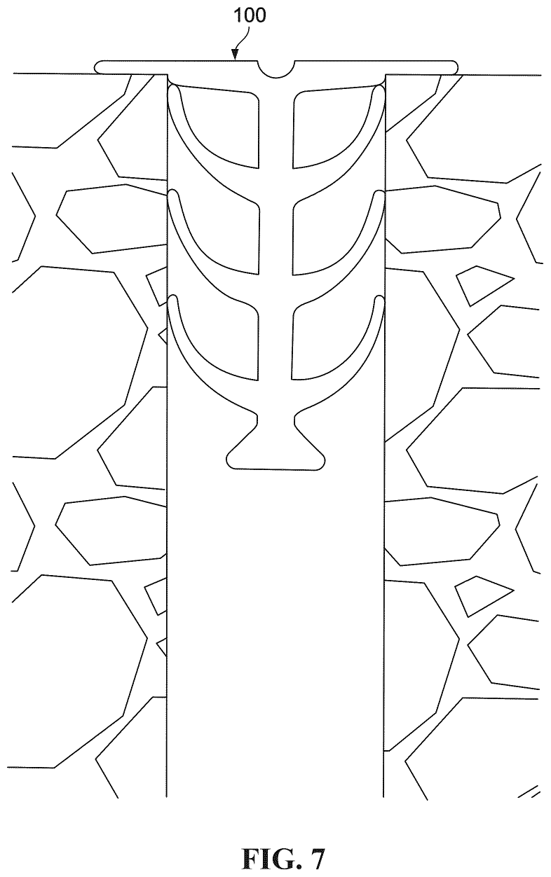

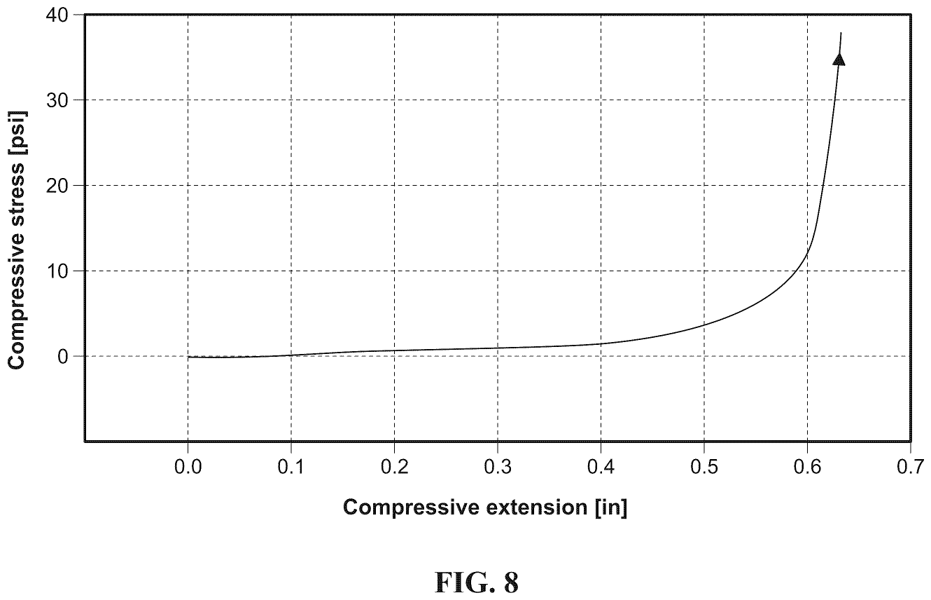

FIG. 8 shows a compression deflection curve for the seal 1 (this is a result from a test to measure the force to compress an objection, such as through ASTM D575). In an embodiment, at the minimum joint opening of about 0.375″, the maximum force is only 3.22 psi. Compared to the compression deflection curve of preformed sealant A shown in FIG. 1C and indicating a 20 psi compressive stress, the force and stress applied in the trench by seal 1 is much less and therefore is less damaging to the trench. In an embodiment, seal 1 is a low force seal that may provide an effective seal in materials that have different compressive qualities and horizontal strength than that of concrete, such as asphalt. In an embodiment, seal 1 may provide an effective seal in such materials, may not disrupt the structure of the materials in the walls of the trench or surrounding surface (e.g. prevent shoving, rutting, depressions, cracking, upheaval, disintegration, and other failures or distress), and may allow access to the underlying utilities after installation. The seal 1 may also provide a cost effective and low profile solution, minimizing the time, expense, resources, and obstruction to the road or walkway during and after installation.

### EXPERIMENTAL DATA

A Marshall test may be used as a quality control tool for evaluating asphalt mixtures. Marshall stability and flow may also be used to relatively evaluate different mixes and the effects of conditioning. In this method, the resistance to plastic deformation of a compacted cylindrical specimen of a bituminous mixture is measured when the specimen is loaded at a deformation rate of 50 mm per minute. The current method, however, is only suitable for testing asphalt mixes rather than a sample of asphalt or asphalt that has already been in place. The results disclosed herein indicate that a modified Marshall test could be used to determine if asphalt or pavement that is already in place may be suitable for use with a particular sealant. The modified Marshall test may comprise making ¼ cut made through the core to represent the trench sidewall as noted in more detail below.

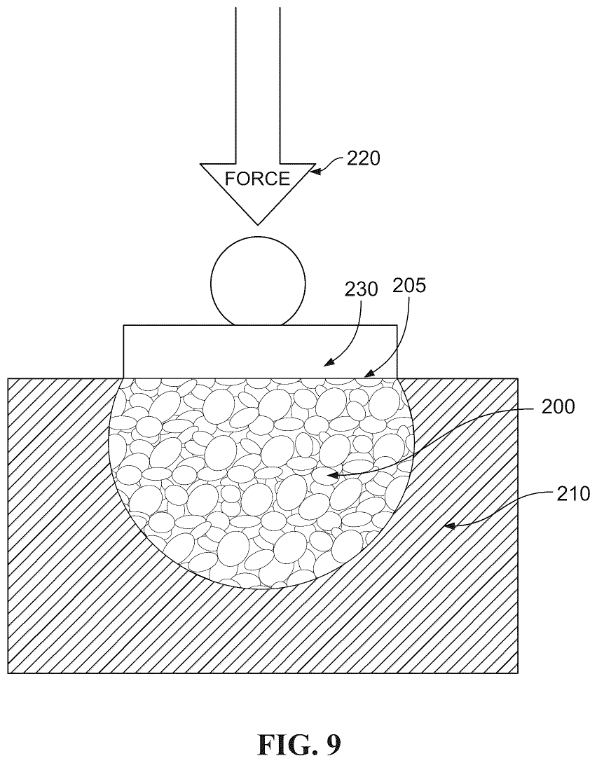

Experimental data was acquired using a modified Marshall test applied to various samples of asphalt to determine compatibility with the seal 1. Testing was performed using testing cores 200, an example of which is shown in FIG. 9. The testing cores 200 were taken and formed from asphalt testing sites at various locations as described herein. A testing core 200 having a diameter of 6 inches sample was used as it is large enough to measure force distribution, but not too large to make testing cumbersome.

Since the asphalt or pavement would be used for a trenching application, a fresh cut through the testing core 200 was carried out to determine and evaluate properties. A cut in the testing core 200 was made at ¼ the diameter of the testing core 200 to ensure adequate material was left for testing and to eliminate any corner effects. The testing core 200 was constrained in an epoxy form 210 to provide proper support of the testing core 200 when force 220 is applied. A force 220 of 3.22 psi was used based on the corresponding deflection curve, see FIG. 8. The epoxy form 210 also represented an infinite plane of asphalt. A bar 230 was used to transfer the load 220. The bar 230 had 1 inch by 1 inch dimensions with an area of 4.988 in². This area represented the height of the seal 1 that may be in contact with the trench or asphalt surface when installed. The testing cores 200 were cut to a 2 inch depth. The bar 230 was aligned with the top edge 205 of the testing core 200 to simulate sealing the top of the trench. Testing was performed on an Instron 3366 test frame with an environmental chamber installed for testing at elevated temperatures. For elevated temperature testing the samples were conditioned in a Tenny environmental chamber for 24 hours at 140° F. and 80% RH.

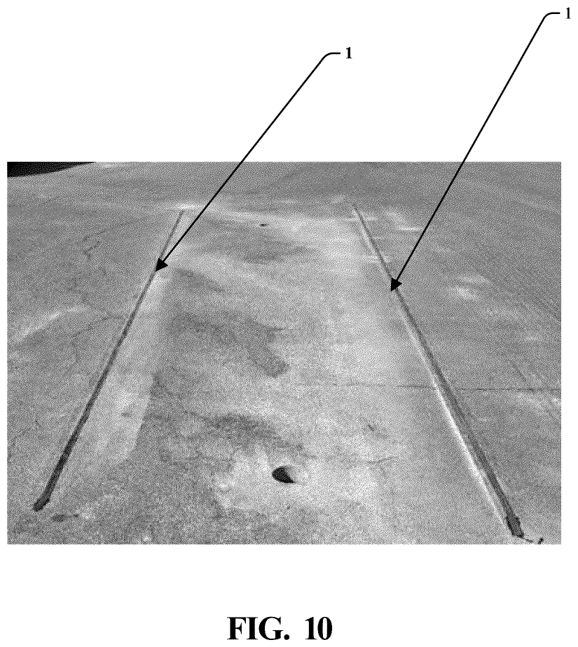

Test sites were selected to ensure a relatively good sampling of materials. Test sites varied from extreme heat and sun to cold and wet climates, and pavement condition varied from new to old and worn. At six test sites, two trenches were cut having a 25 foot length and 1-2 testing core 200 samples taken. At one test site, a single trench having a 45 foot length was cut and no testing cores 200 were able to be taken due to the location being a city street. Testing cores 200 were taken with a diamond hole saw. Trenching was performed using a Ditch Witch MT9 trenching saw mounted on an SK1050 Mini Skid Steer. A half inch saw blade was used. Trenches were cut 3-5 feet apart with a target trench dimension of 0.625 inches and 4-5 inches in depth. The trenches were then backfilled with sand to create a seal reservoir that was 1.5 inches deep. Seal 1 was installed at each location. FIG. 10 shows an exemplary installation in a trench in Sacramento, CA. These locations, the age and condition of the pavement, the sample date, and notes are shown below in Table 1. Trenches were monitored for 6 weeks for shoving, cracking, or other distress in the asphalt.

TABLE 1

| | | Sample | |
|---|---|---|---|
| Location | Age/Condition | Date | Notes |
| Cincinnati, | 10-15 years, good | Aug. 14, 2019 | Two 25 ft. trenches |
| OH | condition with | | sealed, and two 6-inch |
| | some cracking. | | cores taken. |
| North | 1 year, very good | Aug. 20, 2019 | Three 25 ft. trenches |
| Baltimore, | condition. | | sealed, and two 6-inch |
| OH | | | cores taken. |
| North | 5-10 years, good | Aug. 20, 2019 | One 45 ft. trench |
| Baltimore, | condition. | | sealed, no cores (city |
| OH | | | street). |
| Taylorsville, | 15+ years, very | Aug. 27, 2019 | Two 25 ft. trenches |
| MS | poor condition. | | sealed, and one 6-inch |
| | | | core taken. |
| Manhattan, | 1 year, very good | Aug. 29, 2019 | Two 25 ft. trenches |
| KS | condition. | | sealed, and two 6-inch |
| | | | cores taken. |
| Appleton, | 10-15 years, good | Sep. 4, 2019 | Two 25 ft. trenches |
| WI | condition. | | sealed, and two 6-inch |
| | | | cores taken. |
| Sacramento, | 10 years, good | Sep. 12, 2019 | Two 25 ft. trenches |
| CA | condition with | | sealed, and two 6-inch |
| | some cracking. | | cores taken. |

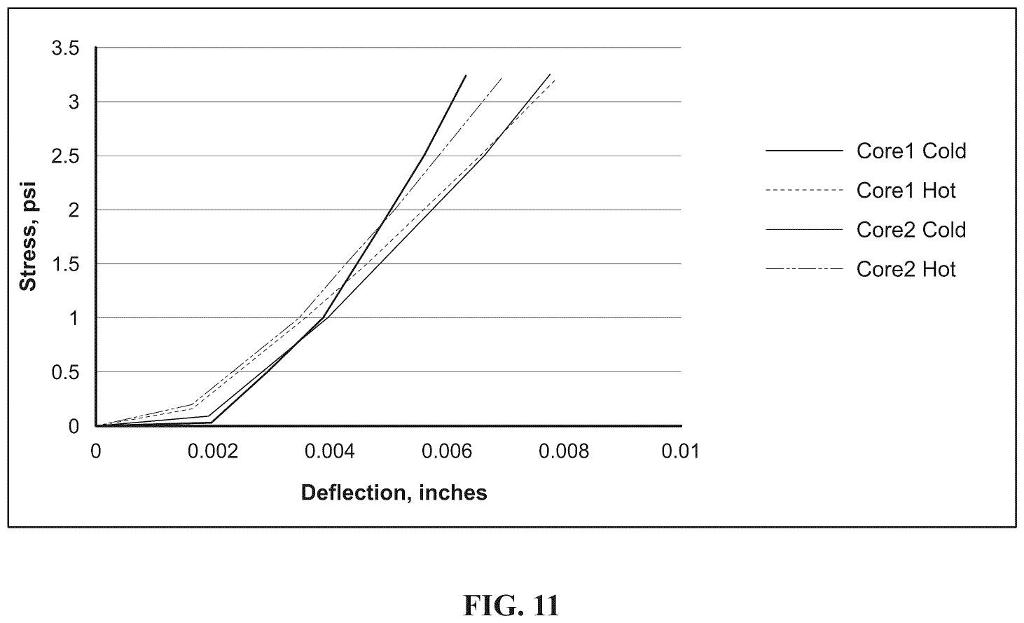

Testing of each testing core 200 began at room temperature. The testing cores 200 were then placed in an environmental chamber for 24 hours at 140° F. and 80% RH for conditioning. Tests were repeated at 140° F. and the results compared. FIG. 11 shows the force and the deflection curves for a set of testing core 200 samples in Cincinnati, OH. Table 2 shows the deflections of pavements at the different temperatures and a comparison of the results thereof. The increasing slope of the curve in FIG. 11 indicates an increased resistance to movement, i.e. minimal deflection. A comparison of the deflections in Table 2 further confirms that there is no evidence of shoving at the 3.2 psi loading. Differences in deflection ranged from 0-0.003 inches.

TABLE 2

| | Deflection | | |
|---|---|---|---|
| | Cold | Hot | Difference |
| NBO1 | 0.00867 | 0.01166 | 0.00299 |
| NBO2 | 0.01010 | 0.01133 | 0.00123 |
| RBI1 | 0.00628 | 0.00697 | 0.00069 |
| RBI2 | 0.00773 | 0.00787 | 0.00014 |
| MS1 | 0.01144 | 0.01404 | 0.00260 |
| MH1 | 0.00643 | 0.00650 | 0.00007 |
| MH2 | 0.00810 | 0.00833 | 0.00023 |
| ASC1 | 0.00981 | 0.01183 | 0.00202 |
| ASC2 | 0.00930 | 0.01210 | 0.00280 |
| SAC1 | 0.00937 | 0.01182 | 0.00245 |
| SAC2 | 0.00557 | 0.00664 | 0.00107 |

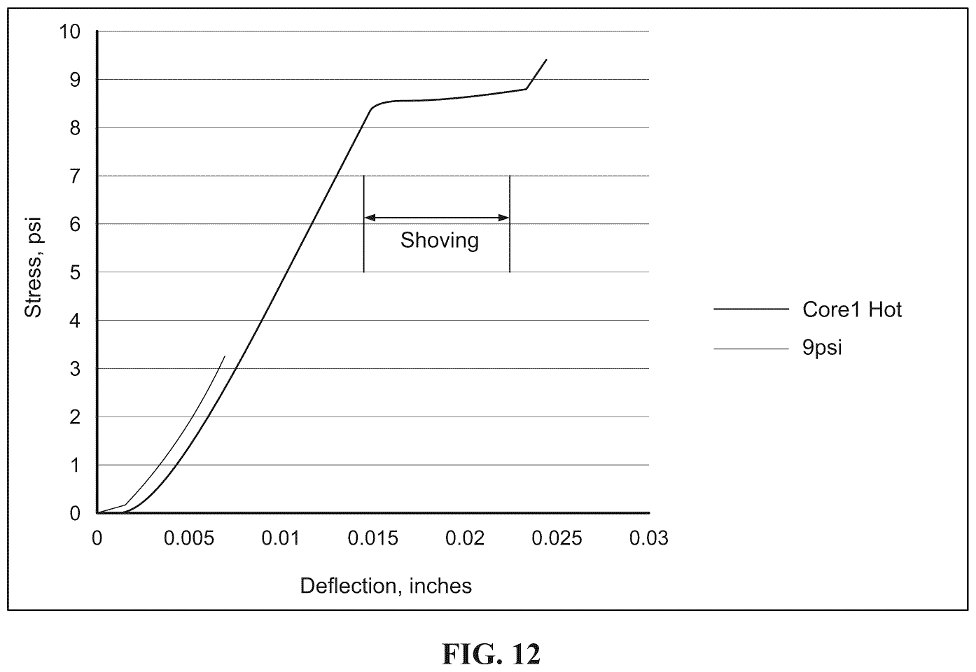

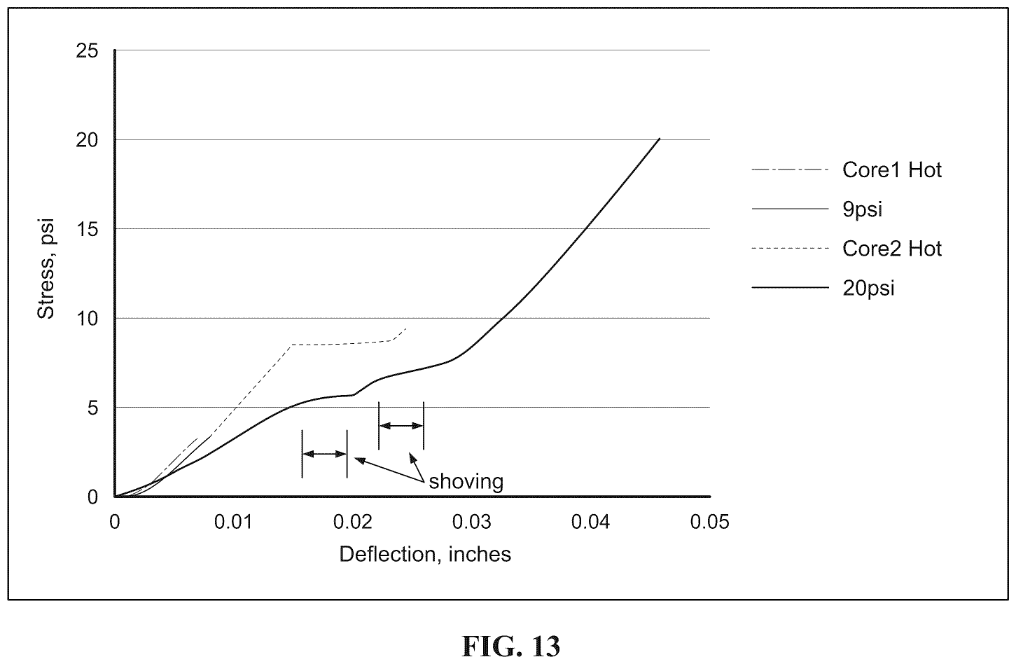

The test method and results were validated by performing a trial in which shoving was detected. Samples were rerun in a hot state to a force of 9.4 psi. This force exceeds the force observed in seal 1. As shown in the Cincinnati, OH sample in FIG. 12, shoving was detected in this higher force experiment by the rapid change in the slope of the curve. The slope of the curve also started to increase again after 0.010 inches of deflection. Testing was repeated on the second testing core to 20 psi in the hot state (since the original preformed sealant A that caused shoving during field trials had a compressive force of 20 psi). The resulting deflection curve is shown in FIG. 13. The curve of FIG. 13 shows there are several changes in slope during the cycle. These changes in slope may be caused by compaction of the material as large aggregates move past each other or break away, causing the slope to change. Overall, this data confirms that seal 1, exhibiting a low compressive force or stress, does not result in shoving of asphalt, whereas preformed sealant A or other sealants exhibiting a higher compressive force or stress, do result in shoving or distress to the asphalt (shown by a jump in deflection over a short stress increase).

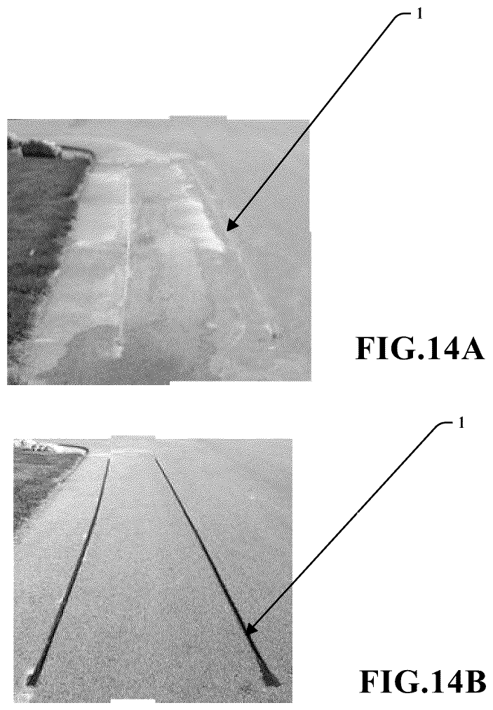

The results of the trial installations confirmed this core testing. None of the sites showed any sign of shoving when seal 1 was installed. FIGS. 14A-B show the trenches performed in Manhattan, KS when the seal 1 was first applied (FIG. 14A) and after 8 weeks (FIG. 14B).

As a result, both the core testing and trial installations show compatibility of the seal 1 in various compositions, types, and ages of asphalts and pavements that are subject to varying environmental conditions. Seal 1, under both core testing and trial installations, did not show shoving or other distress to the asphalt or pavement. Moreover, the results indicated that the preformed sealant A typically used in concrete is, in contrast to seal 1, inadequate and destructive in asphalt and pavement applications.

The results also indicate that the modified Marshall test as created and used herein, can be used to determine if an asphalt or pavement is compatible or incompatible with a sealant, including seal 1 (and preformed sealant A showing incompatibility). Test results showing no sign of shoving can indicate good trench performance after the sealant is installed. The modified Marshall test can also be used to determine the maximum force allowed before pavement failure or, in other words, the amount of force that will induce shoving in the asphalt or pavement once a sealant is installed. Since the strength of material, such as asphalt, pavement, concrete, and the like, can depend on several variables such as age, level of compaction, composition, municipality, use, location, and environmental conditions, there is a need for a test to evaluate the material strength and suitability for a sealant prior to installation. The modified Marshall test addresses this need.

An installation machine and/or platform is contemplated to align the seal with the trench. This machine, platform or system can include a mechanism for compressing the seal so that it can be installed in the trench, a discharge blade that installs the seal, and a compaction wheel that ensures that the seal top flange is in intimate contact with the pavement surface. The installation machine includes a carriage for holding reels of seal that can be from 50 feet to 10,000 feet in quantity.

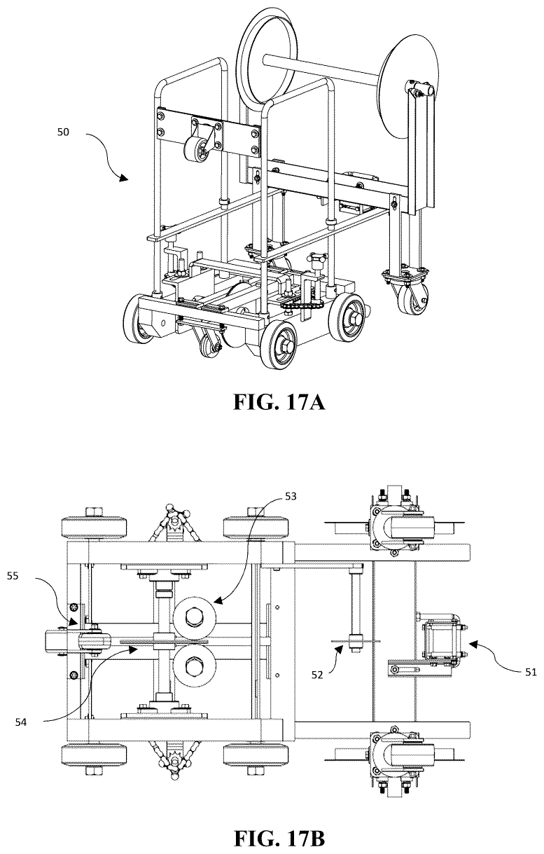

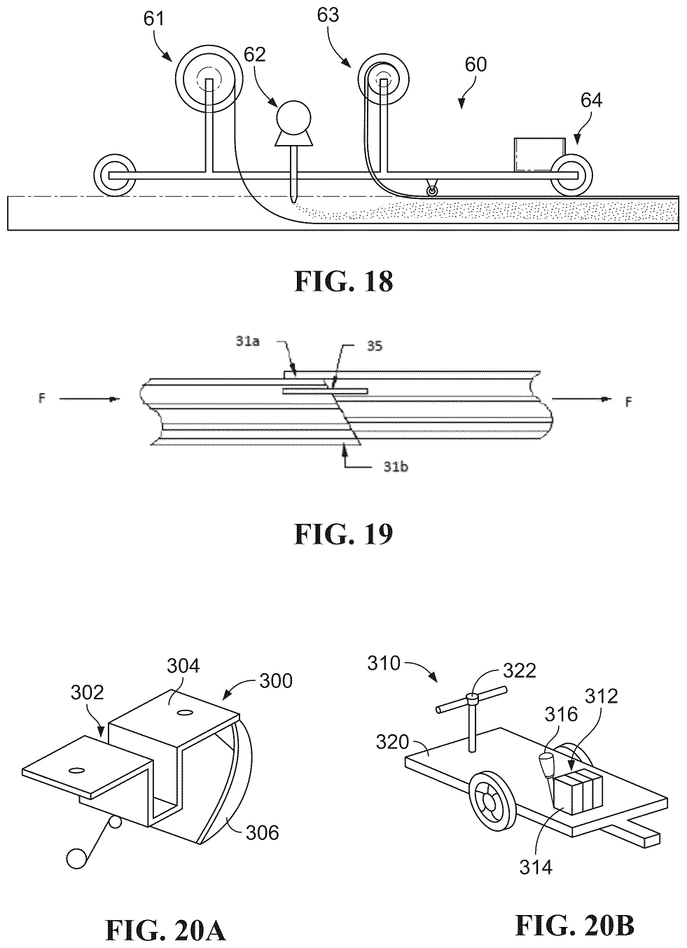

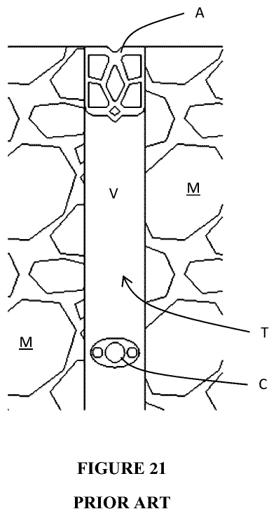

With reference to FIGS. 17A, 17B, and 18, as well as United States Patent Publication US20100080653A1 (which is incorporated by reference), the aspects disclosed above can entail a continuous operation in which the seal is mechanically installed immediately after the foam has been placed. The apparatus 50 for installing the seal should include a guide mechanism 51 for aligning the seal with the trench opening in the proper orientation. Wheels or other mechanisms 53 compress the seal while discharge blade 54 places the seal in the trench opening. Final level of the seal in the trench is accomplished by a compaction wheel 55. The machine should include a locating device 52 to keep itself centered in the trench opening.

Ideally all the equipment would be installed in one platform 60. Fiber is placed in the trench at the beginning of the platform by way of spool or dispenser 61. Downstream from this operation, the foam backfill is deposited into the bottom of the trench by pumping mechanism 62. Finally, a spool or dispenser 63 places the seal so as to complete the reinstatement. The platform 60 should be flexible enough to allow for installation around turns and over changes in pavement elevation, possibly by employing a wheeled chassis 64. Notably, the sequence of operations on the platform 60 is significant, with fiber/utility dispenser 61 proceeding before (e.g., at the leading edge) and the seal placement mechanism 63 at the trailing edge. Foam pumps 62 may be interposed between these items, although a plurality of pumps could be provided before, in parallel with, or after (as shown in FIG. 18) the fiber/utility dispenser 61. Ultimately, the positioning and arrangement of pump(s) 62 should be made with an eye toward maximizing the speed at which foam is deposited and cures within the trench. Consideration as to the source of the foam (i.e., bulk kit, continuous addition, hand mixing, etc.) also influences the plumbing arrangement for platform 60.

FIG. 19 shows orientation of trailing edge 31a and leading edge 31b relative to the direction F of installation/unwinding (e.g., during the operation of system 50). As shown here, a diagonal cut is made through the top flange of the lead edge 31b, although s similar operation can be performed on the trailing edge 31a. Staple 35 is installed through portions of each edge 31a, 31b, with the understanding that the terminal edges (not visible) of the staple 35 are bent or crimped by the fastening implement to insure that the staple 35 is held in place within each member associated with edges 31a, 31b. In this manner, the separate seal members are coupled and move in concert along the line of installation F. Further, because conventional staples are immediately crimped and affixed as they are dispensed, the operator needs to create only a minimal amount of slack in the spool carrying the trailing edge 31b in order to couple the members together. That is, the speed of installation of staples avoids the need for adhesive seals to cure. As noted above, the fastening implement can even be integrated into the cutting tool so as to streamline and simplify the installation system. Further still, the simplicity of staples enables use of this arrangement in any number of disparate, existing trench forming platforms/apparatus.

FIGS. 20A and 20B show exemplary schematics for embodiments of the cutting tool (FIG. 20A) and how it might be implemented on a mobile platform (FIG. 20B). Handheld or freely manipulated tool 300 defines a channel or secure gripping slot 302 with flanges 304 on either side. A cutting blade 306 is affixed to one edge. Alternatively, a platform based tool 310 includes spaced apart blocks 314 defining the slot 312, with a blade 316 positioned proximately. Tool 310 is carried on a mobile platform 320 fitted with a T-shaped spool carrier 322.

In view of the foregoing, one aspect of the invention relates to a seal member for a micro trench. The seal member may be formed as a continuous web and positioned around a spool or reel. The seal member includes a top flange, a central body extending orthogonally down from a middle portion on an underside of the top flange, a plurality of protrusions extending radially away from the central body, and an engagement feature positioned at a lower terminal end of the central body. Additional aspects may include any one or combination of the following features:
wherein the engagement feature has a triangular or V-shaped cross sectional profile;
wherein the top flange includes a central hinging groove formed on a top facing;
wherein at least one of the plurality of protrusions each includes a hinging groove;
wherein the plurality of protrusions extend radially away from the central body at a shorter radial distance than the top flange;
wherein the plurality of protrusions include one or more pairs positioned at an identical axial height on opposite facings of the central body;
wherein the pairs of protrusions each have a different radial extension, with a shortest radially extending pair positioned immediately next to the engagement feature;
wherein the pairs of protrusions have progressively shorter radial extensions so that a longest radially extending pair is positioned immediately next to the top flange and the shortest radially extending pair is positioned immediately next to the engagement feature; and
wherein the plurality of protrusions extend perpendicularly away from the central body.

A further aspect relates to a system for sealing a micro trench. This system includes all of the various aspects of the seal member identified in the previous paragraph, along with at least one selected from: i) an adhesive applied to a portion of the seal member, and ii) a curing foam used as a reinstating material. This system may also be provided on a mobile platform that is configured to transport and dispense the seal member and the foam/the adhesive. When the mobile platform is used, it may also have a guide mechanism, a discharge blade, a compaction wheel, and/or a plurality of storage tanks configured to mix a curing agent with the foam and/or the adhesive as it is dispensed. The system and mobile platform can both incorporate, either as a standalone member or as part of the guide mechanism or discharge blade, a cutting tool and fastening implement, wherein the fastening implement delivers a staple through the seal members. Any of these aspects of the system might also include one or a combination of the following:
wherein the foam is an elastomer configured to: i) flow around the seal member prior to curing and ii) adhere to the sealing member and any adjacent surface during and after curing;
wherein the foam includes urethane and/or silicone;
wherein the foam forms open or closed cell upon curing;
wherein the foam has a cream time of 1-30 seconds, a gel time of 2-60 seconds, and a tack free time 3-120 seconds; and
wherein, when cured, the foam has a core density of 0.5-60 pounds per cubic foot and a compressive strength of 2-200 psi.

Finally, a method for sealing and/or reinstating a micro trench is contemplated. The method includes forming a micro trench in a hardened surface at a first rate of speed and positioning a sealing member having any of the characteristics identified above to seal the hardened surface at a second rate of speed and wherein the second rate of speed is equal to or faster than the first rate of speed. Additional steps for this method might include: i) coating the seal member with an adhesive as the seal member is positioned within the trench and/or ii) providing an curable foam (having any of the qualities mentioned above) into the micro trench simultaneous to or immediately after the seal member has been positioned in the micro trench. When a curable foam is used, the additional step of mixing the foam composition with a curing agent as the foam is provided into the micro trench is a still further aspect of the method. The method might also involve providing the seal member by winding elongated strips of the seal member onto a plurality of spools so that a first spool feeds the seal member into the micro trench and, prior to the seal member being completely unwound from the first spool, splicing a trailing edge of the seal member from the first spool with a leading edge of the seal member wound on the second spool.

The aforementioned systems are advantageous in comparison to those conventional systems in several regards. Foremost, the use of foam allows for the trench backfill operation to proceed at the same rate as the initial cutting of the trench. In contrast, conventional systems employing cementitious grout, sand, asphaltic material, or elastomeric patching (or some combination of these materials), result in a reinstatement rate of eight feet per minute. However, conventional cutting saws used to form microtrenches may proceed at twenty five feet per minute or higher. Thus, various disclosed aspects of the invention identified herein improves significantly upon previously known rates of reinstatement. In some aspects, the structures and methods contemplated herein enable the rate of reinstatement to match the rate of conventional cutting saws, thereby leading to faster installation, reduced traffic impairment, and reduced overall costs in comparison to the conventional reinstatement methods noted above.

Notably, matching the operation of the system (e.g., cutting saw speed/rate, speed of movement, etc.) may include formulating the properties of the adhesive, the foam, and other flowable fluids accordingly, in terms of viscosity, cure time, cream time, temperature during mixing/dispensing, mixing time, etc., By way of example rather than limitation, it is possible to adjust to the resident time the foam is expected to be in dispensing lines and/or the micro trench both prior to and while the gasket is being positioned to ensure proper setting and curing. In the same manner, if the final composition is made from multiple components/compounds, each one can be stored, conditioned, and dispensed in a unique manner. Further, owing to the fact that speed/rate of unspooling of the gasket may vary as the reel winds down, the volume, rate, and other characteristics for dispensing fluids can be adjusted as needed. Similarly, the formulation of the fluids may remain constant or be adjusted during operation of the system to meet the aforementioned needs (or others).

Yet another advantage of the gaskets disclosed herein is that they may be extruded to create elongated seal members that can be spooled for storage and then dispensed during micro trench reinstatement. This arrangement allows for the efficient transportation and dispensing of the gaskets with minimal intervention required by the end user.

The use of symmetrical arms ensures that placement and orientation of the gasket is irrelevant, so long as the gasket remains at or near the center line running down the length of the micro trench.

To the extent the need for reinstating material or foam is eliminated, the system will reduce material costs. The installation of gaskets without reinstating material is also simplified.

In those embodiments in which the utility or cable does not come into contact with either the gasket (or the reinstating material, because no such material is needed), risk of damage to the utility/cable by way of compressive force/loads and/or by way of unwanted chemical reactions or other degradation (between the fill and the cable and/or the gasket and the cable) is minimized or eliminated. In that same manner, gaskets that remain completely below grade shield the utility/cable from loads and mitigate wear and tear and/or accidental displacement of the gasket/seal itself.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define embodiments disclosed herein. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Still further aspects of the invention are as follows:

The present disclosure endeavors to describe a new set of spoolable seal members primarily for use in micro trenches. These seal members (also referred to as gaskets) can be used in combination with open or closed cell, curable foam to create a micro trenching system, although some aspects only need the gasket itself. The seal member can be removable and serviceable in selected instances. Use the seal member, particularly in combination with foam reinstatement material, results in a sealed micro trench that is water tight, comparatively resilient, and resistant to damage caused by heavy usage and/or environmental factors. Adhesive coatings can be employed as part of system that insures the gasket remains secured in the micro trench.

The seal members according to any of the disclosed aspects will have suitable compressive strength to support the trench walls but without damaging adjacent pavement (or other roadway/surface materials). Their construction will also accommodate expansion and contraction caused by changes in temperature (i.e., the freeze/thaw cycle) and/or traffic load while remaining firmly locked into any reinstating material (when used). Certain aspects allow for partial compression and deformation of the middle and/or top portions of the gasket, so as to ensure a good fit within the trench and even receive a surface/grade level fill for aesthetic or practical purposes, while others are designed to engage the reinstating fill material(s) to retain and position the gasket.

In some aspects, partially or completely closed cells in the seal member body section allow for the insertion of or co-extrusion with/around one or more cables or utilizes, which case the entire process for reinstating the micro trench can be streamlined and expedited. While the gaskets are all envisaged as being extruded so as to form a single unitary member, it may also be possible to coextrude complimentary materials when forming the gasket so as to improve the structural properties of selected portions (e.g., more flexible materials in the arms vs. more rigid, less expensive, and/or higher density materials in the body).

The gaskets herein can be provided as a spooled material, making them ideally suited for existing installation machines. Spooling also enables the seal member to be dragged, dabbed, or otherwise exposed to an adhesive, as well as fitted over, around, or onto a concurrently laid cable/utility during placement into the trench. Spooling is also a convenient means for storage after the initial extrusion/manufacture of the seal.

When used, the foam may be provided as a two part liquid, making it ideal for storage in and in situ dispensing from tanks. After the parts are mixed, the resultant material can flow and expand around any objects positioned within the trench (e.g., the utility line(s), the seal member, etc.) and then cure into a closed or open cell solid material. Adhesives compatible with the gasket and micro trench materials can be used in addition to or in place of foam in certain aspects.

In some aspects, the gasket can be provided as a stand-alone gap filler (rather than as an overlay for cables or other utilities normally disposed in a micro trench). In such instances, the micro trench dimensions remain the same, and the gasket serves as much as an expansion joint as it does a protective seal for the underlying trench.

The sealing system and method may accommodate multiple parallel and/or intersecting/perpendicular micro trenches within a given road, street or other pathway/surface, irrespective of whether provided through intersections of cross streets or at various junctions from a mainline in a street to an end user/property adjacent to that street. The system is capable of withstanding vehicle and/or pedestrian travel, varying environmental conditions, and other wear and tear. Additionally, the disclosed micro trench seal may allow for removal, targeted replacement of the utility, and reuse, all while maintaining integrity of the original micro trench.

The system is also configured to operate continuously by relying upon tooling that enables the splicing of seal members from separate spools without pausing operations (i.e., without stopping cutting, reinstating, or sealing of the micro trench). Additional aspects include the provision of multiple spools adjacent to the dispensing system so as to enable quick change-out. Still other aspects are directed toward winding of “mega-spoools” in which large sections of gasket (possibly exceeding 500, 1,000, and up to several thousand linear feet) are provided on a single reel that has been specially adapted to allow for manipulation, loading, and placement of that reel into a dispensing system by a single operator.

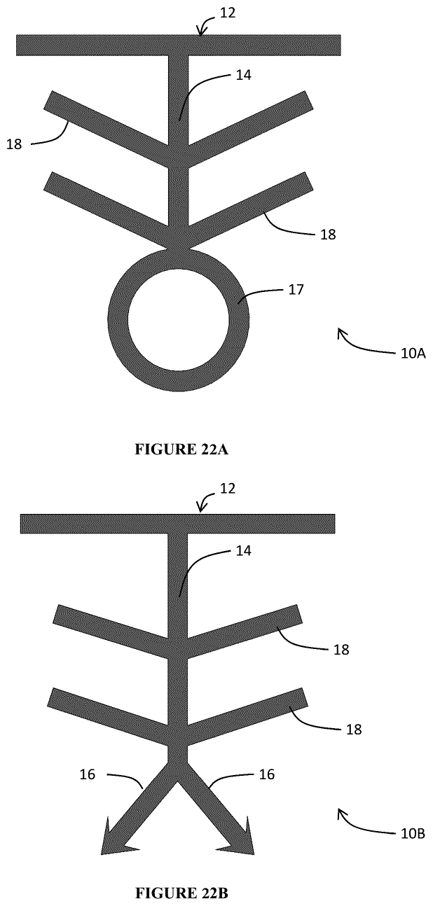

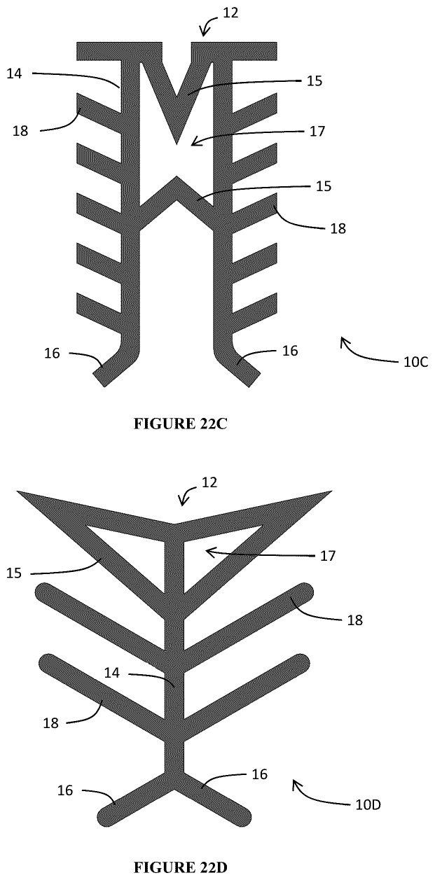

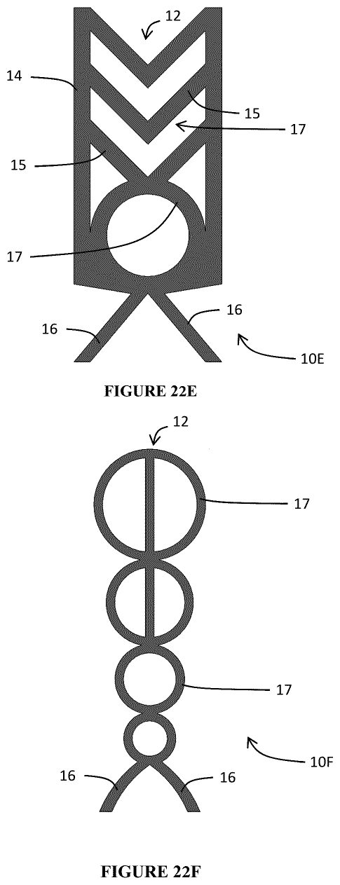

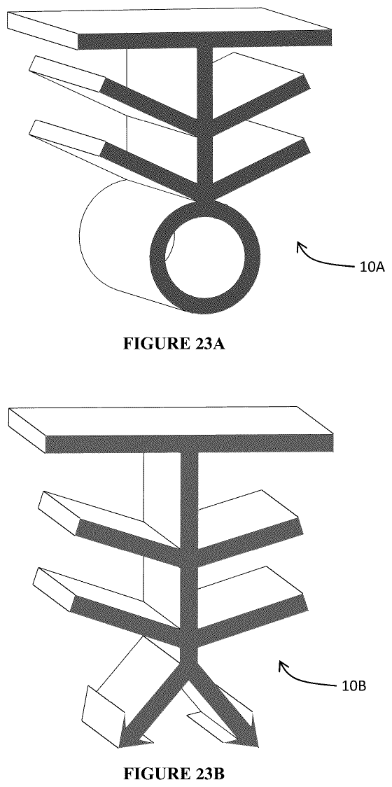

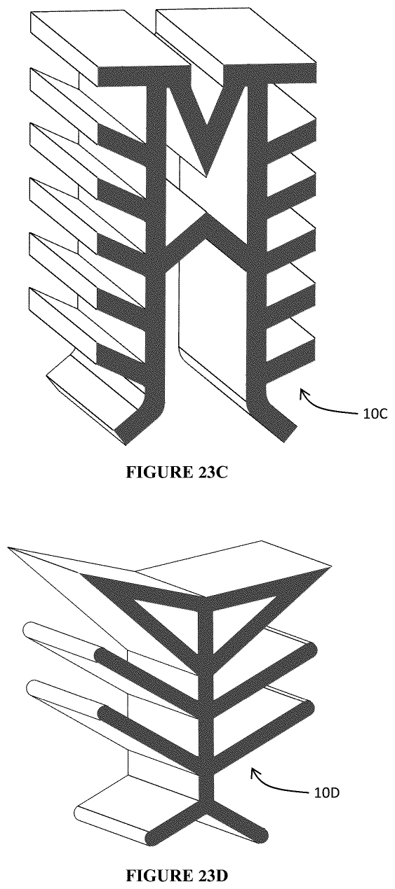

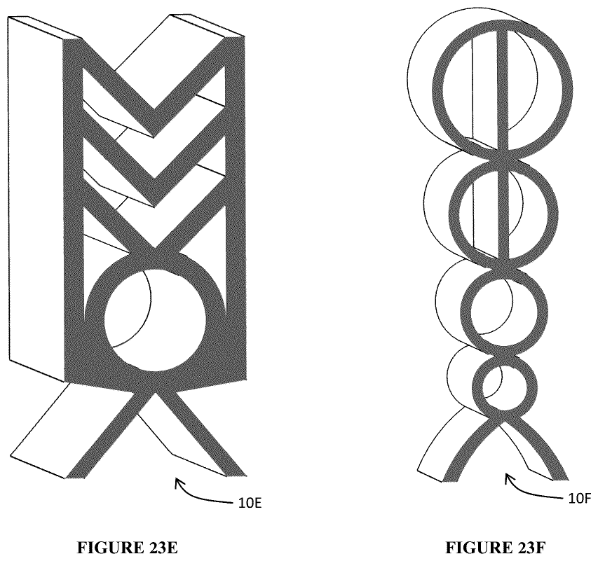

Turning to FIGS. 22A to 23F, a variety of differently shaped seal members can be used with or without the foam/reinstatement material. For the sake of simplicity and clarity, there are subsets of features that are common to multiple depicted embodiments, so that the following definitions and terminology may be useful: i) “top seal” refers to facing 12 of the gasket 10 that remains exposed or most easily accessible after the gasket is installed in the trench; ii) “body” refers to the main section 14 immediately beneath the top seal; iii) “legs” or “legged” refers to the lower extremities 16 of the body, usually in the form of two or a plurality of terminal end branches; iv) “branches” are single solid members 18 extending away from the main body at an angle, usually parallel or at acute angle relative to the horizontal plane defined by the top seal; v) “closed cell” means any structure 17 that is extruded so as to create a void space within the body; and (vi) “chevron” is one or a series of closed cell structures 15 defining at least one V-shaped void. Additionally, certain disclosed embodiments rely on an axial vertical member that may bisect some of the chevrons and/or closed cells. Any chevron or closed cell not having an axial vertical member—and particular the lower-most, exposed chevron/closed cell in any given embodiment—could be modified or subjected to a procedure in which the closed cell(s) is/are slit open so that a cable(s) can be forced fitted into the interior.

Also, as used herein, “axial” refers to the vertical direction as shown in the figures, while “radial” extensions will trace a generally horizontal direction although, unless otherwise stated herein, radial protrusions, extensions, and the like may be provided at a perpendicular or angled orientation relative to the central axis coinciding with the axial length of the main body. Also, references to “trench” and “micro trench” may be used synonymously, depending upon the specific context of their use.

It will also be understood that the gaskets illustrated in cross section can and will be manufactured (e.g., by way of extrusion) in a continuous web to allow them to be reeled around a spool for subsequent dispensing/use. Thus, these cross sections are part of a elongated, continuous body extending in length for hundreds or thousands of linear feet when unspooled (as necessary use in reinstating a micro trench).

With reference to the figures, the gaskets of the invention herein can be categorized into six basic groups: a) branched closed cell (10A); b) branched legged (10B); c) closed cell branched legged (10C); d) chevron branched legged (10D); e) chevron legged (10E); and f) closed cell legged (10F). Notably, these groups are reflected in Table A.

TABLE A

| | | Strength for | | | | |
|---|---|---|---|---|---|---|
| | | going through | Maximize natural | Maximze adhesive | Utilize | Engages with |
| | | installation | pull strength | area for pull | hinge | expanding |
| FIGS. | Taxonomy | equipment | (w/o adhesive) | strength | function | foam |
| 22A, | Branched | X | X | X | X | X |
| 23A | closed cell | | | | | |
| 22B, | Branched | X | X | X | X | X |
| 23B | legged | | | | | |
| 22C, | Closed cell | | X | X | X | X |
| 23C | branched | | | | | |
| | legged | | | | | |
| 22D, | Chevron | X | X | X | X | X |
| 23D | branched | | | | | |
| | legged | | | | | |
| 22E, | Chevron | X | X | X | | X |
| 23E | legged | | | | | |
| 22F, | Closed cell | | | X | X | X |
| 23F | legged | | | | | |

| | Partially fills | Maximize surface | Allow duct(s) to be | Accommodate co- |
|---|---|---|---|---|
| | with expanding | strength for narrow | designed into the | extrusion of an |
| FIGS. | foam | wheels or high heels | rubber itself | embedded fiber duct |
| 22A, | | X | X | X |
| 23A | | | | |
| 22B, | | X | | |
| 23B | | | | |
| 22C, | X | X | | |
| 23C | | | | |
| 22D, | | X | | |
| 23D | | | | |
| 22E, | | | X | X |
| 23E | | | | |
| 22F, | | X | X | X |
| 23F | | | | |

The gaskets depicted in FIGS. 22A to 23F may be inserted into a micro trench in any suitable manner. Because the micro trench includes vertical sidewalls, outer-most portions of the gasket (e.g., the terminal edges of branches, closed cells, and/or chevrons) engage sidewalls. All of these designs may be scaled to meet the particular width and/or depth requirements of a particular micro trench installation.

As noted above, the main body 14 may be a single, solid element generally aligned along the axially length of the gasket 10. Additionally or alternatively, the main body 10 could incorporate closed cell elements 17, such as chevrons, circles, triangles, or other polygons. These closed cell elements 17 may be hollow or bisected by the solid element 14. The closed portion 17 of the cell can accommodate a cable or other element, either by being formed integrally with it or by temporarily or permanently opening the cell (or cells) to fit the cable inside. Chevrons 15 can be individual wall sections in or off of the body 14 and/or form closed cells 17.

Branches 18 can extend radially away from the main body 14 (or the structures forming the central portion), being integrally formed or attached to the sidewalls and facings of the main body element(s). The branches 18 may extend at right angle or with an upward and/or downward acute angle (relative to the horizontal plane delineated by the top facing 12 of the top seal). Each side may possess the same or different numbers of branches. In particular (and as depicted herein), each side may include as few as one or two branches 18 per side, up to as many as five or more (note that the bottom-most legs 16 are not considered or counted as branches in this context). The branches 18 may be straight, curved, or serpentine. The thickness of the branches (as well as any solid member formed on the main body or as part of a closed cell) may remain constant or decrease or taper.

Some or all of the branches 18 may have hinges 11 in the form of divots, notches, grooves, etc. to facilitate bending and installation. When hinged, the expectation is that the distal end of the branch 18 comes into contact with the sidewalls of the trench, causing the branch to bend at the hinge 11 (also see FIG. 25). The branches 18 may extend at identical similar or differing lengths.

In one aspect, the branches 18 closest to the top facing 12 project the largest radial reach, either by way of their length and/or based on their attachment to a closed cell. The branches 18 closer to the bottom preferably have a comparatively shorter radial reach so as to allow foam or fill material to surround and encase the branches during the reinstatement. Particularly when foam is used, this causes the seal to become “locked” in place once the foam cures. However, the top seal should be of sufficient strength (by way of materials selection and/or construction and design) to ensure that foam or other backfill material will be impeded from flowing around the distal edges. In this manner, the seal ensures that foam cannot and will not expand upward out of the trench or to otherwise be visible when the installation is complete.

Multiple branches 18 coming into contact with the body 14/cell 17 (e.g., see FIG. 22D) may also provide continuous sealing so that, if the top seal is damaged or the pavement is compromised at one location, these “lower” branch seals continue to protect the backfill material and the cable from exposure to the elements.

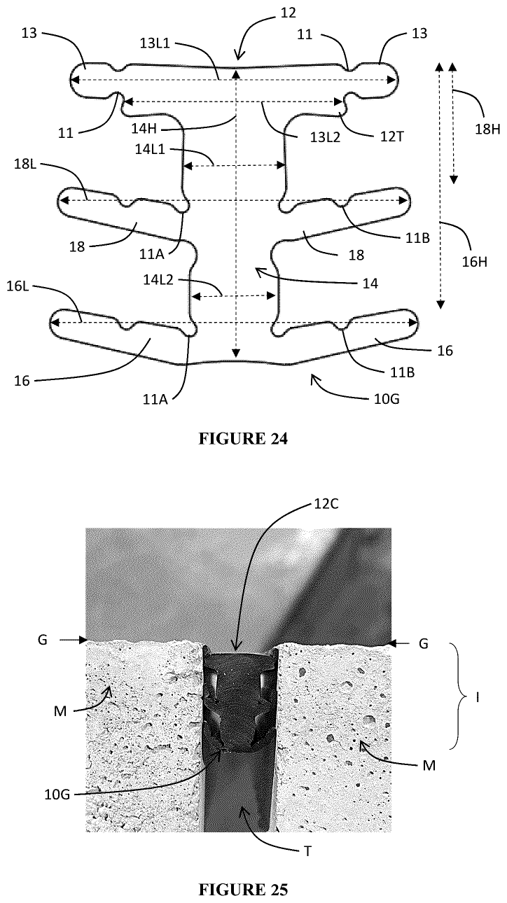

A further aspect is shown in FIG. 24. Here, gasket 10G is specifically designed to eliminate the need for foam or other reinstatement materials through the careful positioning of hinges 11, use of “bear ear” appendages 13, and comparative sizing and angling of branches 18 and legs 16. In some aspects, gasket 10G may also be capable of filling a micro trench without any adhesive. Thus, while gasket 10G retains many of the same features as described in FIGS. 2A to 3F, it will be understood that the features and their comparative traits (relative to one another) are of particular importance.

Notably, gasket 10G utilizes a considerably thicker main body 14 in comparison to the other aspects disclosed herein, although the structures comprising the gasket 10G are preferably symmetrical about its central axis 14H. This increased thickness imparts the gasket 10G with sufficient mass to remain fixed between the sidewalls of the trench while remaining above and out of contact with any cables or other utilities seated in the bottom of the micro trench.

The increased body thickness manifests in at least two discrete areas: (i) an axially thicker section 12T extends radially away from axis 14H in order to define top facing 12; and (ii) in the body 14 itself, at sections defined by lines 14L1 and 14L2. In some aspects, the thickness 14L1>14L2, with 14L1 preferably being between 15% to 30% longer than 14L2. Further, the aspect ratio of the body 14 (14H/14L1) is between 2.25 and 3.25, with 2.75 to 2.85 being preferred.

Another significant feature relates to the bear ear appendages 13 provided at the distal ends of sections 12T. Appendages 13 are somewhat bulbous and spaced apart from section 12T by a thinned hinge section 11, as will be described below. More significantly, the appendages 13 have a smaller axial thickness in comparison to section 12T, with the thickest part of appendage 13 being about one half the thickness in comparison to section 12T. In the same manner, the thicker section 12T will be thicker than either any single individual branch 18 or the leg 16.

This arrangement allows for the solid body 14 of gasket 10G to be pushed down into the micro trench while appendages 13 engage and seal to the top inner edge of the trench (see FIG. 5). Thus, the portion of radial length along line 13L1 constituting one of the appendages is approximately equal to the depth of the groove 12C (which is preferably about one eight of an inch in some aspects). Also, the radial span from appendage end to appendage end is defined by line 13L1. In some aspects, line 13L1 the axial height 14H of the body is about the same or between ˜80% to ˜95% in comparison to appendage length 13L1.

The bulbous appendages 13 should be symmetrically formed with an axial height that is smaller than that in the thickened section 12T. Further the radial length (as measured along line 13L2) of that thickened section 12T should be between 60% to 75%—and more preferably about two thirds—of the radial reach 13L1 of the appendages. These dimensions ensure the seal 10G will consistently insert downward into the micro trench in order to form groove 12C, as described below.

A single pair of branches 18 are spaced axially apart and beneath the thickened section 12T. The axial spacing should be sufficient to allow the branch 18 to bend upward and maintain contact with the micro trench sidewall while not displacing or interfering with the appendages' 13 own point of contact (also see FIG. 5). In some aspects, the axial distance 18H from the top-most facing of the appendage 13 to the top-most facing at the terminal end of the branch 18 is about one third to one half the total axial height 14H of the gasket 10G, with a more preferred range of between 40% to 45%.

Each branch 18 has a hinge 11A at its top facing at the base junction connected to the main body 14. An additional hinge 11B is provided near the midpoint of each branch 18 to impart sufficient flexibility to ensure smooth installation. End-to-end, the branches have a radial span defined by line 18L, with 18L>13L (and preferably with 13L being between 85% to 95% of 18L).

A single pair of legs 16 are also provided. Here again, the axial spacing of the legs 16 relative to the branches above them is sufficient to allow the leg 18 to bend upward and maintain contact with the micro trench sidewall while not displacing or interfering with the branches 18 own point of contact (also see FIG. 25). In some aspects, the axial distance 16H from the top-most facing of the appendage 13 to the top-most facing at the terminal end of the branch 18 is about 75% to 95% of the total axial height 14H of the gasket 10G, with a more preferred range of between 80% to 90%.

Similar to the branches 18, hinges 11A are provided at the base/junction and midpoint hinges 11B of each leg 16 improve flexibility. The radial span 16L of the legs 16 is such that 16L>18L (and preferably with 18L being between 85% to 95% of 16L). In some aspects, the axial spacing between the thicker section 12T and the branch 18 is the same as or slightly greater than that between the branch 18 and the leg 16.

In a preferred aspect, the branches 18 and legs 18 join to the body at an acute angle (rather than perpendicular) relative to axis 14H. Further, the angle formed by the branch-to-body junction should be approximately the same as that formed by the leg-to-body junction, meaning that the branches and legs are oriented in a substantially parallel arrangement. This helps to ensure, as the gasket 10G is inserted, that the legs and branches make and maintain contact with the sidewalls of the trench but without providing undue resistance. Comparatively speaking, the perpendicular orientation of the appendages 13 relative to axis 14H may require greater force so that the installer (manual or automated) will be able to sense and calibrate the force needed accordingly.

The provision of axially thinned hinges 11, 11A, 11B, as well as their number and approximate location, further facilitate the operation of the gasket 10G as it is installed in the micro trench. These hinges are formed as grooves or thinned areas (relative to the surface on which they are formed). The depth of the grooves will be less than one third or one quarter of the thickness of the component in which they are formed (i.e., along an axial thinkness at that groove). In some aspects, the depth is between approximately 5% and 15% of the component's axial thickness, but they can be effective even at as little as 2%. If the branch or leg is angled upward, the aforementioned thickness for the grooves forming the hinge is relative to a line that is normal to the surface of that component.

As previously noted, hinges 11A are preferably provided at the junction point of each branch and each leg in comparison to the main body. The midpoint hinges 11B are within +/−15% of the midpoint for the component on which they are provided, while the pair of hinges 11 defining each appendage (one on the top surface and one on the bottom surface) are substantially closer to the distal ends of the top facing, preferably so that they are within 25% or less on line 13L. In some aspects, the hinges are between 10% to 20% of 13L (when measured from the distal end). The distance for the positioning of the hinges 11, 11A, 11B, as well those pertinent to their depth, are taken at the narrowest section of the hinge.

Seal member 10G is particularly well-suited for use in micro trenches less than 1.50 inches wide and less than 2.00 inches deep (preferably less than 1.50 inches). The comparatively “boxy” shape imparted by the aspect ratio ranges and number and positioning of the branches, legs, and appendages ensures a good fit within trenches of this size. When installed in the micro trench, the main body and upturned appendages, branches, and legs will occupy more than 50%, more than 75%, and up to 80% or even 90% of the free volume in the portion of the trench where the gasket 10G is positioned (see region I FIG. 25).

While not specifically indicated in FIGS. 22A through 23F, it should be understood that hinges can be provided in the branches and/or legs for those aspects. Hinge-like thinned sections can also be formed in the wall or walls defining a closed cell 17, as these thinned sections could serve as hinges and/or as separation points so that a cable or utility could be force fitted into that cell.

The gaskets 10A through 10G are ideally formed or extruded from an appropriate elastomeric compound selected for the particular temperature and pressure conditions encountered in trenching operations. In one embodiment, the material can be a thermoset elastomer material. In another embodiment, the resin material can be a thermoplastic material. In other embodiments, the material may be a combination of the foregoing. The material can be resistant to environmental conditions such as water, ozone, oxidation, and UV.

The shapes inherent to each taxonomy group (as indicated in Table A), as well as the foam-free aspects encompassed by FIG. 24/gasket 10G, may be formed using an extrusion process followed by curing/heat treatment and/or coating to achieve its final desired properties prior to being spooled. The gaskets can be machine molded, insert molded (relative to the cable and/or in combination with discrete elements, like the top seal, protrusions, tendrils, etc.), extruded, or coextruded (again, relative to the cable and/or based upon a desire to utilize specific and distinct materials in particular sections of the gasket).

Extrusions should be particularly useful insofar as they involve single continuous step so as to facilitate spooling, while molding operations may provide greater versatility for shorter and/or specialized gasket sections. In some aspects, the gaskets may be formed from the same material or different portions of the seal 1 may be formed from different materials that are subsequently adhered, welded, or otherwise bonded together. For example, the outermost protrusions (i.e., their sides or ends) may be formed from a more flexible rubber material or the top seal(s) may be formed from harder materials able to withstand wear from environmental conditions and use.

In some aspects, the top seal 12 may be removable from the main body 14, whether it is one or more axial vertical members and/or closed cells. In these instances, if the top seal becomes damaged or worn, it could be removed and replaced without disturbing the remainder of the gasket. The top seal could also be removed with a coating of bituminous crack filler added in its place (thereby delaying complete removal of the gasket). The top seal may also be configured to become detached upon certain threshold pressure or conditions so that the remainder of the gasket remains in the micro trench in the event the top seal is pulled, detached, dislocated, or otherwise removed unintentionally or intentionally (e.g. getting caught by a snow plow, street cleaner, truck, car, pedestrian traffic, vandals, etc.).

The top or exposed facing(s) of each gasket 10A to 10F may present planar, flat, domed, rounded, squared, or other concave or convex shapes in comparison to the level ground, as may be desired or required by the installation. The top seal (i.e., the exposed portion that remains visible/accessible after the gasket is installed in the micro trench) is of sufficient width to span the entire trench and lay generally flat on the pavement surface, or it may lie such that it remains exposed only a centimeter or less is above or below the adjacent surface.

The top seal, branches, legs, and/or sidewalls may include one or more notches, grooves, or divots running along the extruded length of/in these features. These various features can be formed during the initial manufacturing process, or they can be selectively or continuously created at the installation site or even as the gasket is being unspooled.

In some aspects, the radial reach of the top seal could be larger than the width of the micro trench so as to be deliberately not fully inserted. In these instances, the gasket would need to be forced below grade (as shown and further described in FIG. 5) or to reside above grade as an intentionally formed “bump”. However, it will be understood that the inventors envision the ability to position the top facing below grade as a significant advantage in comparison to conventional systems.

In this regard, gasket 10G is specifically designed so that the top seal rests below grade G after it is installed, as is clearly depicted in FIG. 5. Here, the indent or groove 12C helps to form a seal and provide additional force-fitting to secure the gasket in the micro trench by way of the appendages 13 being forced downward. The axial spacing of the legs 16, branches 18, and thickened section 12T is such so that the majority of the top facing sits below the grade G of the surface in which it is installed while the outermost radial edges of the seal, while the longer radial reach of the legs 16 and branches 18 in comparison to the appendages 13 ensure the gasket maintains an interference and/or adhesive fit along the sidewalls of the micro trench below grade G and below the contact point maintained by the appendages 13. Further, notches 11, 11A, 11B provide natural hinge points where the gasket is specifically designed to flex/bend.

Another advantage of gasket 10G, in comparison to other disclosed aspects herein, is that the legs 16 extend upward, so as to minimize the risk of contact with, and damage to, the utility or cable concealed in the trench. In essence, gasket 10G presents a flat or even concave surface underneath its main body. The elimination of features intended to surround the utility or to engage reinstating foam/fill also allows for greater variation/deviation from the center line of the micro trench. Nevertheless, the deliberate and necessary contact of the arms with the micro trench sidewalls will serve as a natural means of centering and maintaining the position of the gasket as it is unspooled and installed in the micro trench.

When present, groove 12C (and, in some aspects, the concave features formed in the top seal of gaskets 10A to 10F) may run the entire length of the trench and serve as a collection point for loose sand, gravel, or other material that might collect or be deliberately deposited over the seal for aesthetics purposes. Further, because the concave features cause the majority of the seal (the body 14, chevrons 15, cells 17, etc.) to remain below grade, it substantially alleviates or may even eliminate the need for the seal 10 to serve as a temporary load bearing member when vehicular and/or foot track passes over the final trench.

The top seal and main body can conform exactly to the width of the trench. In some aspects, this top facing 12 can also be painted. These arrangements should be particularly useful in keeping debris or water out of the micro trench. However, owing to natural variations during trenching, such perfect fitment is not necessary or required.

The provision and location of hinges 11, usually in the form of thinned wall sections in a branch 18 or leg 16, may also be specifically selected to maximize sealing_yet control the outward force that would disturb asphalt (or whatever the adjacent materials forming the sidewalls of the trench may be). In this manner, less pressure is applied to the side walls wherever the asphalt in the micro trench might be the weakened. For example, the asphalt may be weaker toward the top of the opening of the micro trench. As a result, the protrusions inserted into this area of the micro trench may include a hinge to reduce the force and prevent too much force to be applied. On the other hand, the side walls of the micro trench may be stronger further down into the micro trench. As a result, the protrusions inserted into this area of the micro trench may not need a hinge, especially to the extent damage can be caused by the force required to overcome friction between the sidewalls and the gasket during installation. Non-hinged protrusions may also allow for more secure fitment upon curing of the foam or backfill material. The hinge can be formed at the gasket's point of manufacture, or in situ as needed at the installation site based upon the dimensions of the micro trench, conditions of installation, etc.

Legs may be employed at the very bottom of the gasket. These legs may help to position the gasket relative to the bottom of the trench, as well as to provide surfaces that will be secured within the backfill material. In some aspects, the cable can be fitted, molded, or co-extruded between and around the legs. Preferably, when used, two legs are provided, although aspects may include one, two, three, four, or more legs. The number of legs will be limited, in part, by the width of the trench, so that the practical limit for many micro trench applications will be two legs. Also, the legs are preferably formed at a larger downward angle in comparison to branches (if any are used).

Tendrils, such as arrow-like barbs or other small projections, may be integrally formed or created on the branches or legs. Tendrils may be formed at a small scale by surface roughing, or they can be included in the mold or extrusion die.

After the trench is cut and the utility is placed at the bottom of the trench a foam and/or backfill material can be sprayed or pumped into the trench. Before the foam fully reacts and cures, the gasket is inserted in the top of the trench to confine the foam material within the trench. That is, the material may first fill part or all of the trench, or the material and the gasket can be placed simultaneously.

In an embodiment, an adhesive may be used to facilitate the installation of the gasket into the micro trench. The adhesive may be spray on, paint on, stick on, or the like. In an embodiment, a machine may be used to control the volume of an adhesive, such as a spray on adhesive, applied during installation. In some aspects, as the seal member is disposed within the trench, it may be coated, dragged through, or otherwise come into contact with a curable adhesive. Additionally or alternatively, adhesive could be disposed on and/or in the trench (sidewalls, top ledge, etc.) in a separate operation prior to inserting the gasket. This adhesive would bond the seal member to the utility line(s) and/or the trench walls, so as to maintain the desired positioning of the seal member throughout the trenching and reinstating procedures. However, use of the adhesive—and of the foam itself—can be dictated by the conditions and needs of the installation. When used, the adhesive may be any common adhesively, preferably water based or a two-part system. The adhesive should have a high enough viscosity to have a lubricating effect and a long enough open time to allow for adjustment of seal depth. Adhesive is particularly useful, but not necessarily required, in systems and installations relying on gasket 10G.

When an adhesive is not used, the gasket must be forced fitted downward into the micro trench with sufficient force to create an interference fit between the inner facings of the micro trench (i.e., its sidewalls) and the arms, legs, and appendages of the gasket. In this manner, the main body is also forced down below grade so as to minimize the profile of the gasket. In these instances, the interference fit will be sufficient to retain the gasket in place and seal the micro trench. Further, this arrangement can allow for the width of the micro trench to expand or contract without displacing or tearing the gasket (instead, the reach and angle between the vertical axis and the arms, legs, and appendages can vary to accommodate these movements).

The gasket may be customized by slitting or cutting and discarding unwanted sections on the distal edges (most likely on the side, but possibly at the bottom and/or top). Notches may serve as guides for preferred attachment points, such as between branches and/or on the branches themselves. These arrangements provide greater flexibility and allow for the gasket to be adapted on site as needed or dictated by installation conditions. For example, the gasket is normally inserted to a depth that allows the top seal to remain flush with the surface of the pavement, but portions of the bottom can be removed along sections where the trench depth is too shallow. Conversely, if the micro trench is cut excessively deep, it is possible to partially fill the trench with dry fill material such as sand or spoils left over from when the trench was cut or to temporarily increase the volume of backfill material (e.g., foam) over the length of that section.

Staples are attractive in part because of their ubiquitous nature. Further, they immediately couple members by having their opposing terminal edges of the staple penetrate the seal member, after which the staple edges are crimped inward so as to hole the staple securely in place. Simple U-shaped members made of copper, steel, other metals, sturdy plastics, or any other material that is sufficiently strong enough to pierce the material selected for the seal member and to withstand crimping. Other possibilities include clips, which rely on a biasing member to hold the edges together, and/or double-ended receiving joints where the edges can be slid into and/or secured to opposing sides of the joint member.

The fastening implement can be a stand alone feature, such as a hand held stapler so as to provide the operator with greater freedom to manipulate and position the necessary components. Alternatively, the stapling mechanism could be integrated within a portion of the cutting tool so as to guarantee consistent and proper positioning of the trailing and leading edges throughout the splicing operation (i.e., positioning the separate edges, cutting/removing a portion of one of the edges, and coupling the edges via the fastener/fastening implement).

A cutting tool can be used to simplify, standardize, and improve the quality and appearance of splicing disparate ends of the gasket (i.e., from different spools/reels).

An installation machine and/or platform is contemplated to align the seal with the trench. This machine, platform or system can include a mechanism for compressing the seal so that it can be installed in the trench, a discharge blade that installs the seal, and a compaction wheel that ensures that the seal top flange is in intimate contact with the pavement surface. The installation machine includes a carriage for holding reels of seal that can be from 50 feet to 10,000 feet in quantity.

The apparatus for installing the seal should include a guide mechanism for aligning the seal with the trench opening in the proper orientation. Wheels or other mechanisms compress the seal while discharge blade places the seal in the trench opening. Final level of the seal in the trench is accomplished by a compaction wheel. The machine should include a locating device to keep itself centered in the trench opening.

Ideally all this equipment, including the spools/reels/gasket would be installed in one platform. Fiber is placed in the trench at the beginning of the platform by way of spool or dispenser. Downstream from this operation, the foam backfill is deposited into the bottom of the trench by pumping mechanism. Finally, a spool or dispenser places the seal so as to complete the reinstatement. The platform should be flexible enough to allow for installation around turns and over changes in pavement elevation, possibly by employing a wheeled chassis. Notably, the sequence of operations on the platform is significant, with fiber/utility dispenser proceeding before (e.g., at the leading edge) and the seal placement mechanism at the trailing edge. Foam pumps may be interposed between these items, although a plurality of pumps could be provided before, in parallel with, or after the fiber/utility dispenser. Ultimately, the positioning and arrangement of pump(s) should be made with an eye toward maximizing the speed at which foam is deposited and cures within the trench. Consideration as to the source of the foam (i.e., bulk kit, continuous addition, hand mixing, etc.) also influences the plumbing arrangement for platform.

Several methods for sealing and/or reinstating a micro trench are contemplated. The first such method includes forming a micro trench in a hardened surface at a first rate of speed and positioning a sealing member having any of the characteristics identified above to seal the hardened surface at a second rate of speed and wherein the second rate of speed is equal to or faster than the first rate of speed. Additional steps for this method might include: i) coating the seal member with an adhesive as the seal member is positioned within the trench and/or ii) providing an curable foam (having any of the qualities mentioned above) into the micro trench simultaneous to or immediately after the seal member has been positioned in the micro trench. When a curable foam is used, the additional step of mixing the foam composition with a curing agent as the foam is provided into the micro trench is a still further aspect of the method. The method might also involve providing the seal member by winding elongated strips of the seal member onto a plurality of spools so that a first spool feeds the seal member into the micro trench and, prior to the seal member being completely unwound from the first spool, splicing a trailing edge of the seal member from the first spool with a leading edge of the seal member wound on the second spool.

Another method of reinstating a micro trench is particularly advantageous because no foam or reinstating material (e.g., gravel, sand, pavement, etc.) is needed to fill the interstices between the utility/cable and the gasket. Instead, the gaskets provided are of sufficient volume to provide a substantial portion (75% or more) of the volume above the utility/cable. In the method, a micro trench is formed having a width of up to 1.50 inches (3.81 centimeters) in a concrete or solid paved surface. Optionally, a utility is disposed within a lower portion of the micro trench. A gasket is place or overlaid in the micro trench so that the gasket is not in physical contact with the utility. In some aspects, an adhesive coating is provided or applied to opposing sidewalls on the inner and/or upper surfaces of the micro trench prior to overlaying the gasket in the micro trench.

Notably, in this method where reinstating material is not needed, the gasket includes: i) a main body, ii) a top facing extending radially further than the main body, iii) appendages provided at each transverse edge of the top facing so that the main body flexes downward into the micro trench when the gasket is overlaid, and iv) at least two arms extend radially away from the main body at a larger radial reach than possessed by the top facing, with the at least two arm spaced axially beneath the top facing. Further, any one of combination of the following conditions could apply: the adhesive coating comes into contact with at least one selected from the appendages at each transverse edge and/or the at least two arms so as to attach the gasket on each of the opposing sidewall surfaces; the gasket includes a second set of symmetrically formed arms interposed between the at least two arms and the top facing; no fill material (e.g., foam, gravel, rock, dirt, sand, etc.) is provided to the micro trench; the gasket has a transverse cross section, relative to the width of the micro trench, that occupies at least 75% of a total volume of the micro trench where the gasket is overlaid; and/or the main body is positioned at least one eighth of an inch (0.32 centimeters) below a level grade of the concrete or solid paved surface.

1. A seal member for a micro trench, the seal member comprising:
a top flange;
a central body extending orthogonally down from a middle portion on an underside of the top flange;
a plurality of protrusions extending radially away from the central body; and
an engagement feature positioned at a lower terminal end of the central body.

2. The seal member of claim 1 wherein the engagement feature has a triangular or V-shaped cross sectional profile.

3. The seal member of claim 1 wherein the top flange includes a central hinging groove formed on a top facing.

4. The seal member of claim 1 wherein at least one of the plurality of protrusions each includes a hinging groove.

5. The seal member of claim 1 wherein the plurality of protrusions extend radially away from the central body at a shorter radial distance than the top flange.

6. The seal member of claim 1 wherein the plurality of protrusions include one or more pairs positioned at an identical axial height on opposite facings of the central body.

7. The seal member of claim 6 wherein the pairs of protrusions each have a different radial extension, with a shortest radially extending pair positioned immediately next to the engagement feature.

8. The seal member of claim 6 wherein the pairs of protrusions have progressively shorter radial extensions so that a longest radially extending pair is positioned immediately next to the top flange and the shortest radially extending pair is positioned immediately next to the engagement feature.

9. The seal member of claim 1 wherein the plurality of protrusions extend perpendicularly away from the central body.

10. A system for sealing a micro trench, the system comprising the seal member of claim 1 and at least one selected from: i) an adhesive applied to a portion of the seal member, and ii) a curing foam used as a reinstating material.

11. The system of claim 10 wherein the foam is an elastomer configured to: i) flow around the seal member prior to curing and ii) adhere to the sealing member and any adjacent surface during and after curing.

12. The system of claim 10 wherein the foam includes urethane and/or silicone.

13. The system of claim 10 wherein the foam forms open or closed cell upon curing.

14. The system of claim 10 wherein the foam has a cream time of 1-30 seconds, a gel time of 2-60 seconds, and a tack free time 3-120 seconds.

15. The system of claim 10 wherein, when cured, the foam has a core density of 0.5-60 pounds per cubic foot and a compressive strength of 2-200 pounds per square inch.

16. The system of claim 10 wherein the system includes a mobile platform configured to transport and dispense the seal member and the adhesive and/or the foam.

17. The system of claim 16 wherein the mobile platform includes a guide mechanism, a discharge blade, and a compaction wheel.

18. The system of claim 17 wherein the mobile platform includes a plurality of storage tanks configured to mix a curing agent with the foam and/or the adhesive as it is dispensed.

19. A system for continuously sealing a micro trench, the system comprising:
the seal member of claim 1, said seal member provided in sections that are each wound separately around a plurality of spools;
a cutting tool configured to position the central bodies of seal members from a trailing edge of a first spool and the central body of a leading edge of a second spool, the cutting tool including a blade configured to remove a portion of at least one of the trailing edge and the leading edge; and
a fastening implement configured to couple the trailing and leading edges positioned in the cutting tool.

20. The system of claim 19 wherein the fastening implement delivers a staple through the leading and trailing edge of separate sections of seal member.

21. A spoolable, gasket for sealing a micro trench formed in a concrete or solid paved surface, the gasket comprising:
a main body formed from a solid material and having a cross-sectional height:width ratio between 2.25 and 3.25;
a top flange extending radially away from the main body having a thickened section and appendages forming opposing terminal ends on each side of the thickened section;
at least two branches extending radially away from opposing sides of the main body at a greater distance than the top flange, with the at least two branches spaced apart axially below the top flange;
a pair of legs extending radially away from opposing sides of the main body at a greater distance than all of the branches, with the pair of legs spaced apart axially below the pair of branches; and
wherein the gasket is symmetrical about a vertical axis.

22. The gasket of claim 21 wherein the gasket possesses a unitary construction so that the main body is integrally formed along with the top facing, the at least two branches, and the pair of legs.

23. The gasket of claim 21 wherein the gasket is extruded or co-extruded from a rubber-like polymer, a thermoplastic material, and/or a thermoset elastomer.

24. The gasket of claim 21 wherein the appendages have a bulbous shape with an axial thickness that is equal to or less than one half an axial thickness of the thickened section.

25. The gasket of claim 21 wherein hinges are provided in top facings of at least one of the top flange, the at least two branches, and the pair of legs.

26. The gasket of claim 21 wherein the cross-sectional height:width ratio is between 2.75 and 2.85.

27. The gasket of claim 21 wherein the thickened section has between 60% to 75% of a radial extension in comparison to the top flange.

28. The gasket of claim 21 wherein the top flange has between 85% to 95% of a radial extension in comparison to the at least two branches.

29. The gasket of claim 21 wherein the top flange has between 80% to 90% of a radial of extension in comparison to the pair legs.

30. The gasket of claim 21 wherein axial spacing between the pair of legs and the at least two branches is similar top axial spacing between the pair of branches and the top flange.

31. A method of reinstating a micro trench, the method comprising:
forming a micro trench having a width of up to 2.00 inches (5.08 centimeters) in a concrete or solid paved surface;
disposing a utility within a lower portion of the micro trench;
providing an adhesive coating on opposing sidewall surfaces in the micro trench;
overlaying a gasket in the micro trench so that the gasket is not in physical contact with the utility;
wherein the gasket includes: i) a main body, ii) a top facing extending radially further than the main body, iii) appendages provided at each transverse edge of the top facing so that the main body flexes downward into the micro trench when the gasket is overlaid, and iv) at least two arms extend radially away from the main body at a larger radial reach than possessed by the top facing, with the at least two arm spaced axially beneath the top facing; and
wherein the adhesive coating comes into contact with at least one selected from the appendages at each transverse edge and/or the at least two arms so as to secure the gasket on each of the opposing sidewall surfaces.

32. The method of claim 31 wherein no fill material is provided to the micro trench.

33. The method of claim 31 wherein the gasket has a transverse cross section, relative to the width of the micro trench, that occupies at least 75% of a total volume of the micro trench where the gasket is overlaid.

34. The method of claim 31 further comprising exerting sufficient downward force on the gasket so that the top facing of the gasket is positioned below grade of the concrete or solid paved surface and each of the branches, legs, and appendages maintain an interference fit with inner facings of the micro trench.

35. The method of claim 34 wherein the main body is positioned at least one eighth of an inch (0.32 centimeters) below a level grade of the concrete or solid paved surface.

36. A method of reinstating a micro trench, the method comprising:
forming a micro trench having a width of up to 1.50 inches (3.81 centimeters) in a concrete or solid paved surface;
overlaying a gasket into the micro trench, wherein the gasket includes: i) a main body, ii) a top facing extending radially further than the main body, iii) appendages provided at each transverse edge of the top facing so that the main body flexes downward into the micro trench when the gasket is overlaid, and iv) at least two arms extend radially away from the main body at a larger radial reach than possessed by the top facing, with the at least two arm spaced axially beneath the top facing; and
exerting sufficient downward force on the gasket so that the top facing of the gasket is positioned below grade of the concrete or solid paved surface and each of the branches, legs, and appendages maintain an interference fit with inner facings of the micro trench.
